(19) United States
(12) Patent Application Publication
(10) Pub. No.: US 2023/0316197 A1
(43) Pub. Date: Oct. 5, 2023

(54) COLLABORATIVE, MULTI-USER PLATFORM FOR DATA INTEGRATION AND DIGITAL CONTENT SHARING

(71) Applicant: LOCOMEX, INC., Newark, DE (US)

(72) Inventor: Ayokunle O. Jemiri, Newark, DE (US)

(21) Appl. No.: 18/016,558

(22) PCT Filed: Jul. 16, 2021
(86) PCT No.: PCT/US2021/042037

§ 371 Date: Jan. 17, 2023

Related U.S. Application Data
(60) Provisional application No. 63/052,731, filed on Jul. 16, 2020.

(51) Int. Cl. G06Q 10/0637; G06N 20/20

(52) U.S. Cl. CPC G06Q 10/0637; G06N 20/20

(57) ABSTRACT

Exemplary embodiments of the present disclosure relate to a collaborative, multi-user platform can utilize a collaborative diversity resources planning and supply chain localization platform powered by artificial intelligent (AI). The collaborative, multi-user platform can utilize artificial intelligent (AI) and machine learning (ML) model to generate predictions and recommendations for users that can guide the users through, for example, bid generation for projects.

### RELATED APPLICATIONS

This application claims priority to and the benefit of U.S. Provisional Patent Application No. 63/052,731, filed on Jul. 16, 2020, the disclosure of which is incorporated by reference herein in its entirety.

### BACKGROUND

As quantity and disparity of data grows, the ability to utilize such data in a meaningful way can decrease. Additionally, this deluge of data can result in data silos that can be to data and relationships between the data difficult to identify and leverage. Many organizations struggle to navigate the sheer quantity of data they collect or produce. The inability of organizations to utilize and extract value from this data can be detrimental to the prosperity of the organizations over time. This can be particularly true, where the data can inform decision making. For example, in the context of supply chain and project workflows, organizations typically rely on a subset of the possible set of available data to inform their decisions on how to bid on a project limiting their ability to generate successful bids.

### SUMMARY

Exemplary embodiments of the present disclosure provides a collaborative, multi-user platform that is focused on supplier diversity and ESG planning and supply chain localization, connecting large enterprises and government agencies with small and diverse business. The collaborative, multi-user platform can utilize artificial intelligent (AI) and machine learning (ML) model to generate predictions and recommendations for users that can guide the users through, for example, bid generation for projects.

In accordance with embodiments of the present disclosure, systems, methods, and non-transitory machine-readable media are disclosed for a collaborative, multi-user platform. One or more non-transitory computer-readable media can store the platform and data associated with one or more users and one or more projects. A processing device can execute the platform to generate one or more graphical user interfaces through which the users interact with the platform to facilitate supplier diversity planning and supply chain localization delivery for one or more phases of the one or more projects, create proposal or bid documents by automatically or semi-automatically generating data for pre-bid intelligent reports, and track a status of the one or more projects and supplier diversity and local content associated with the one or more projects.

In accordance with embodiments of the present disclosure, the processing device can execute the platform to train an ensemble of machine learning models based on training data that includes at least supplier data and project data, the ensemble of machine learning models having a tiered hierarchical configuration; and execute the trained ensemble of machine learning models to automatically or semi-automatically generate data for pre-bid intelligent reports, proposals or bid documents. The trained ensemble of machine learning models includes a first tier formed by at least two different machine learning models and a second tier formed by at least one other machine learning model that is different than the at least two machine learning models in the first tier. The at least two machine learning models of the first tier include a random forest model and an extreme gradient boost model. The at least one machine learning model of the second tier is a neural network model. The at least two machine learning models in the first tier are configured to be executed in parallel. The at least one machine learning model in the second tier receives outputs from the at least two machine learning models in the first tier and generates a final output based on the outputs from the at least two machine learning models.

Any combination and/or permutation of embodiments is envisioned. Other objects and features will become apparent from the following detailed description considered in conjunction with the accompanying drawings. It is to be understood, however, that the drawings are designed as an illustration only and not as a definition of the limits of the present disclosure.

### BRIEF DESCRIPTION OF THE DRAWINGS

FIG. 1 depicts an exemplary embodiment of the collaborative, multi-user platform in accordance with embodiments of the present disclosure.

FIG. 2 depicts exemplary environments for implementing embodiments of the collaborative, multi-user platform in accordance with embodiments of the present disclosure.

FIG. 3 depicts a block diagram of an exemplary computing device that can be utilized to implement one or more components of an embodiment of the collaborative, multi-user platform.

FIG. 4 depicts an exemplary graphical user interface that can be generated by the small and medium business (SMB) portal of an embodiment of the collaborative, multi-user platform to facilitate user/company registration.

FIG. 5 depicts an exemplary flowchart illustrating a process for registering a user/company in the collaborative, multi-user platform in accordance with embodiments of the present disclosure.

FIG. 6-17 illustrate exemplary graphical user interfaces of the SMB portal for an embodiment of the collaborative, multi-user platform for registering a company with the collaborative, multi-user platform.

FIG. 18 is an exemplary graphical user interface providing a list of companies registered on an embodiment of the collaborative, multi-user platform.

FIG. 19 is a flowchart illustrating an exemplary process for interaction between users, Project Owners, Prime Vendors and Suppliers within a defined “Project”.

FIG. 20 depicts a graphical user interface for creating a new project in an embodiment of the collaborative, multi-user platform.

FIG. 21 depicts a graphical user interface identifying existing projects created by a project manager in an embodiment of the collaborative, multi-user platform.

FIG. 22 depicts a graphical user interface identifying existing projects for a supplier in an embodiment of the collaborative, multi-user platform.

FIG. 23 is a flowchart illustrating an exemplary process for interaction between users, Project Owner and Prime Vendor within the invoice tracker subsystem of an embodiment of the collaborative, multi-user platform.

FIG. 24A-B are graphical user interfaces of a main interface of the invoice tracker subsystem in accordance with embodiments of the present disclosure.

FIG. 25A-C are graphical user interfaces for invoice forms for a prime vendor, a supplier, and a project owner that are rendered by the invoice tracker subsystem in accordance with embodiments of the present disclosure.

FIG. 26 is a graphical user interface of a print/upload window of the invoice tracker subsystem in accordance with embodiments of the present disclosure.

FIG. 27 is a graphical user interface providing a revision history provided as list by the Diversity Planning and Team Optimizer subsystem in accordance with embodiments of the present disclosure.

FIGS. 28A-B are graphical user interfaces of forms for the project owner and the supplier in the Diversity Planning and Team Optimizer subsystem in accordance with embodiments of the present disclosure.

FIG. 29A-B are graphical user interfaces for rendering resources within the form for the supplier in the Diversity Planning and Team Optimizer subsystem in accordance with embodiments of the present disclosure.

FIG. 30 is a graphical user interface for rendering a selected labor list in the Diversity Planning and Team Optimizer subsystem in accordance with embodiments of the present disclosure.

FIG. 31 is a graphical user interface for rendering a library of selectable labor options in the Diversity Planning and Team Optimizer subsystem in accordance with embodiments of the present disclosure.

FIG. 32 is a graphical user interface for rendering a selected equipment list in the Diversity Planning and Team Optimizer subsystem in accordance with embodiments of the present disclosure.

FIG. 33 is a graphical user interface for rendering a library of selectable equipment options in the Diversity Planning and Team Optimizer subsystem in accordance with embodiments of the present disclosure.

FIG. 34 is a graphical user interface for rendering a selected material list in the Diversity Planning and Team Optimizer subsystem in accordance with embodiments of the present disclosure.

FIG. 35 is a graphical user interface for rendering a library of selectable materials options in the Diversity Planning and Team Optimizer subsystem in accordance with embodiments of the present disclosure.

FIG. 36 is a graphical user interface for rendering a request list form for a prime vendor in the Diversity Planning and Team Optimizer subsystem in accordance with embodiments of the present disclosure.

FIG. 37 is a graphical user interface for rendering a new request form for a prime vendor in the Diversity Planning and Team Optimizer subsystem in accordance with embodiments of the present disclosure.

FIG. 38 is a graphical user interface for rendering a request list form for a supplier in the Diversity Planning and Team Optimizer subsystem in accordance with embodiments of the present disclosure.

FIG. 39 is a graphical user interface for rendering a contracts list form for a prime vendor in the Diversity Planning and Team Optimizer subsystem in accordance with embodiments of the present disclosure.

FIG. 40 depicts an exemplary graphical user interface for an embodiment of the SMB portal in accordance with embodiments of the present disclosure.

FIGS. 41A-C are graphical user interfaces providing reports including, for example, a diversity report, a general resource report, and a finance report.

FIGS. 42A-D are graphical user interfaces providing libraries including, for example, a SOC library, a regions library, zip codes library, an NAICS library, and a CSI library.

FIGS. 43A-B are graphical user interfaces providing libraries including, for example, a National Institute of Governmental Purchasing Commodity Codes (NIGP) library and a United Nations Standard Products and Services Code (UNSPSC) library.

FIG. 44 illustrates an overview of an implementation of an embodiment of the platform in accordance with embodiments of the present disclosure.

FIG. 45 illustrates an example process flow associated with trained ensemble of artificial intelligence and machine learning models in accordance with embodiments of the present disclosure.

FIG. 46 illustrates a general overview of an AI and ML engine in accordance with embodiments of the present disclosure.

FIG. 47 illustrates an example process for training artificial intelligence and machine learning models of the platform in accordance with embodiments of the present disclosure.

FIG. 48 illustrates a tiered, hierarchical artificial intelligence and machine learning ensemble in accordance with embodiments of the present disclosure.

### DETAILED DESCRIPTION

Exemplary embodiments of the present disclosure relate to a collaborative, multi-user platform that is focused on supplier diversity and ESG planning and supply chain localization, connecting large enterprises and government agencies with small and diverse business on all phases of supply chain lifecycle—from strategic sourcing to project/contract close-out. The collaborative, multi-user platform can utilize a collaborative diversity resources planning and supply chain localization platform powered by artificial intelligent (AI) for optimizing market share and profitability for small businesses and diverse suppliers. In exemplary embodiments, the collaborative, multi-user platform can provide data integration and digital content sharing for small business and diverse supplier enterprise ecosystems and assists in maintaining competitiveness in the digital age. The collaborative, multi-user platform can include a collaborative diversity resource planner platform that de-risks the pre-qualification process.

Additionally, the collaborative, multi-user platform can provide a comprehensive suite of functionalities/features such as a business-to-business-to-government (B2B2G) Marketplace Connector, a small and medium business (SMB) portal, a diversity planning and team optimization subsystem, an invoices tracker subsystem, a connection and integration gateway subsystem, and/or an AI data analytics and reporting subsystem to optimize small and diverse businesses market share and profitability in the capital and asset-heavy energy, utilities, healthcare, construction, etc. sectors.

The collaborative, multi-user platform can significantly save time, improve efficiency and increase quality for the project owners and suppliers while working on supplier diversity and local content policy, legislation and regulatory requirements, and compliance for their projects. Users of the multi-user platform can include project owners, subcontractor/diverse suppliers, government agencies, academia (prof./Students), certifiers, regulators, investors (e.g., ESG investors), etc.

The collaborative, multi-user platform enables small and diverse businesses to join a project owner's supplier diversity and localization programs and allows these business to form teams using a team function of the collaborative, multi-user platform, where several small and diverse companies can come together to create a team and bid for large project as a team. The collaborative, multi-user platform can provide best practices information that can be used to improve the chances of a small and diverse business in winning the project bid. The collaborative, multi-user platform can also provide a proposal/bid document creation function to automatically or semi-automatic generate content and data needed for producing pre-bid intelligent reports.

The collaborative, multi-user platform can be utilized by government agencies (GA), which typically must follow supplier diversity and local content regulations for their projects/procurement plans, publish all their projects/procurement plans via public RFP/tendering web sites, publish their budget/spend plans for next several years period, and/or publish their open data via public web sites and APIs.

The collaborative, multi-user platform can be utilized by prime contractors (PC) that are usually responsible for significant set of government agencies (GA) and Fortune 500 Companies (F5HC) projects, where the PCs typically must follow Supplier Diversity and Local Content regulations and/or policies for GA and F5H project's subcontracts, publish all their projects via public and private RFP/tendering web sites, have their internal corporate social responsibility rules/policies to use local resources and implement supplier diversity for their projects, and/or have their own public RFP/tendering platforms where they publish part of their projects.

The collaborative, multi-user platform can be utilized by small and medium business (SMB), which can be registered in public supplier registration database/SMB portal and/or in several public databases/SMB portal for different supplier diversity certifications. The SMBs typically don't have enough resources to apply for the project's RFP/bid and to deliver the project.

In some embodiments, the collaborative, multi-user platform can be a cloud-based platform or client-server architecture and/or can be integrated with a user's infrastructure. For example, clients, such as GAs, PCs, F5HCs can use the collaborative, multi-user platform as their internal automation tools, where the collaborative, multi-user platform can be deployed in the client's own infrastructure. The modules, user interface (UI), analysis, and/or integrations of the collaborative, multi-user platform can be customized to be client specific. As another example, clients, such as GAs, PCs, F5HCs, and SMBs can interface with the collaborative, multi-user platform in which the platform resides in and executes on one or more servers in a cloud environment, such that here is no need for additional local infrastructure on the client side.

While exemplary embodiments of the present disclosure are illustrate using an example application for project and supply chain processes, exemplary embodiments of the present disclosure can be implemented for other applications. For example, many municipalities can use exemplary embodiments of the present disclosure to track, audit, evaluate, and report on performance of their police departments and ESG.

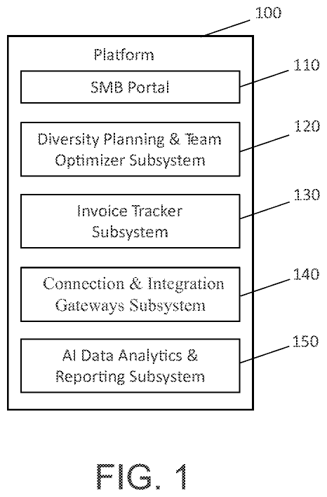

FIG. 1 depicts an exemplary embodiment of the collaborative, multi-user platform 100 in accordance with embodiments of the present disclosure. Embodiments of the collaborative, multi-user platform 100 can include the following subsystems:

| | | Exemplary | Exemplary | Exemplary |
|---|---|---|---|---|
| | Subsystems | Users | Functional areas | Technologies |
| 1 | SMB Portal | SMB | Company | Web |
| | 110 | | registration details | Knowledge |
| | | | (including Diversity | Base |
| | | | certificates, skills, | |
| | | | resources); | |
| | | | Best practices | |
| | | | (including Skills, | |
| | | | Resources | |
| | | | improvement); | |
| | | | Personalized best | |
| | | | RFP offerings | |
| | | | analysis. | |
| 2 | Diversity | GA, PC, | Analysis of projects | Web, Data |
| | Planning | F5H | history information; | Analytics |
| | and Team | | Planned projects | Knowledge |
| | Optimizer | | analysis for | Base |
| | subsystem | | Diverse/Non - | |
| | 120 | | Diverse criteria; | |
| | | | Diversity services | |
| | | | volume analysis; | |
| | | | Optimization of the | |
| | | | project team. | |
| 3 | Invoices | GA, PC, | Invoices registration; | Web |
| | Tracker | F5H, SMB | Invoice preparation | |
| | subsystem | | notification; | |
| | 130 | | Invoicing dashboard; | |
| | | | Cashflow prognosis. | |
| 4 | Connection | GA, PC, | B2B2G Marketplace | APIs |
| | and | F5H, SMB | Connector; | |
| | Integration | | LinkedIn Connector. | |
| | Gateways | | | |
| | subsystem | | | |
| | 140 | | | |
| 5 | AI Data | PC, SMB | Diverse Report; | Web |
| | Analytics | | General resource | |
| | and | | report; | |
| | Reporting | | Project finance report. | |
| | subsystem | | | |
| | 150 | | | |

The following are exemplary user global roles for the collaborative, multi-user platform 100:
1. Project Owner—the company which:
   Owns project and results of the project and knows project details—including exact project location;
   Select Prime Vendors/Suppliers resources (both non-diverse and diverse) for the project through RFPs/Bids/Tenders requests from vendor/suppliers.
   Pay for the work done by vendor/suppliers according to contract agreements and submitted invoices;
   Interested in on-time and efficient invoices payment process because of project KPIs and penalties;
   Have good understanding of what resources/skills/professions are needed for the project;
   Have good understanding of how many resources of each type will be required for the project;
   Interested in implementing supplier diversity and local content and improving diverse supplier utilization in project/supply chain lifecycle;
   Manages presentations of the projects via Microsoft Teams.
   Communicates with Prime Vendor via Microsoft Teams.
2. Prime Vendor—the company which:
   Have selected Suppliers resources (both, non-diverse and diverse) for the project through RFPs/Bids/Tenders requests from vendor/suppliers.
   Track and manage project status and progress.
   Manages resources of the company.
   Manage resources of the project.
   Have good understanding of how many resources of each type can be provided for the approved project.
   Communicates with Suppliers and Project Owner via Microsoft Teams.
3. Supplier—the company which:
   Selected by Prime Vendor to become Supplier—to do the work or to deliver some resources;
   Issues one or several invoices to the Prime Vendor/Project Owner for the work done (or resources supplied);
   Interested that submitted invoices be paid on-time by the Project Owner or Prime Vendor.
   Manages resources of the company.
   Have good understanding of how many resources of each type can be provided for the approved project;
   Communicates with Prime Vendor via Microsoft Teams.
4. Administrator—this global role for the owner of collaborative, multi-user platform, which has a full access to all products of the platform. This role will not be provided upon company registration.

The following are exemplary user access levels that may be determined or specified for the collaborative, multi-user platform 100:

| | | | | |
|---|---|---|---|---|
| | | Management | | |
| Entities of the | | (create, delete, | Change | |
| platform | View | edit, update) | state | Registration |

Project Owner

| | | | | |
|---|---|---|---|---|
| Company's profile | + | + | | |
| Companies | | | | + |
| Projects | + | + | | |
| Requests | | | | |
| Invoices Tracker | + | | + | |
| DivedIn | + | | | |
| (Team Optimizer, | | | | |
| Diversity planner) | | | | |
| Libraries | + | | | |
| SMB portal 110 | + | + | | |
| Integration Gateways | + | | | |
| AI Data Analytics | + | + | | |

| | | | | |
|---|---|---|---|---|
| | | Management | | |
| Entities of the | | (create, delete, | Change | |
| platform | View | edit, update) | state | Registration |

Prime Vendor

| | | | | |
|---|---|---|---|---|
| Company's profile | + | + | | |
| Companies | | | | + |
| Projects | + | | + | |
| Requests | + | + | + | |
| Invoices Tracker | + | + | + | |
| Diversity Planning | + | + | | |
| and Team Optimizer | | | | |
| subsystem 120 | | | | |
| Libraries | + | | | |
| SMB portal 110 | + | + | | |
| Integration Gateways | + | | | |
| AI Data Analytics | + | + | | |

| | | | | |
|---|---|---|---|---|
| | | Management | | |
| Entities of the | | (create, delete, | Change | |
| platform | View | edit, update) | state | Registration |

Supplier

| | | | | |
|---|---|---|---|---|
| Company's profile | + | + | | |
| Companies | | | | + |
| Projects | + | | | |
| Requests | + | + | + | |
| Invoices Tracker | + | + | + | |
| subsystem 130 | | | | |
| Diversity Planning | + | + | | |
| and Team Optimizer | | | | |
| subsystem 120 | | | | |
| Libraries | + | | | |
| SMB portal 110 | + | + | | |

| | | | | |
|---|---|---|---|---|
| | | Management | | |
| Entities of the | | (create, delete, | Change | |
| platform | View | edit, update) | state | Registration |

| | |
|---|---|
| Integration Gateways | + |
| AI Data Analytics | |

| | | | | |
|---|---|---|---|---|
| | | Management | | |
| Entities of the | | (create, delete, | Change | |
| platform | View | edit, update) | state | Registration |

Administrator

| | | | | |
|---|---|---|---|---|
| Company's profile | | | | |
| Companies | + | + | | + |
| Projects | + | + | + | |
| Requests | + | + | + | |
| Invoices Tracker | + | + | + | |
| Diversity Planning | + | + | | |
| and Team Optimizer | | | | |
| subsystem 120 | | | | |
| Libraries | + | + | | |
| SMB portal 110 | + | + | | |
| Integration Gateways | + | + | | |
| AI Data Analytics | + | + | | |

The SMB portal 110 can provide graphical user interfaces (GUIs) that define an entry point for all users (registered and not registered) of the collaborative, multi-user platform 100 to access the collaborative, multi-user platform 100. A user can register his company through the SMB portal 110 and/or can login through the SMB portal 110 if the company has already registered and a login has already been created. After a user has registered and logs into the collaborative, multi-user platform 100, summary information can be rendered in a graphical user interface by main objects of the collaborative, multi-user platform 100 to which the user has access can be displayed on the user's SMB portal 110. Also, links to new RFP/Tenders announcements (from “B2B2G Marketplaces”, like “US Govt Contract Opportunities”, “NY State Contract Reporter”, etc.) will be placed on this page. The detailed form of the announcement with information about a specific RFP/Tender should be opened by clicking on the link. The menu should also be displayed according to access level of the user.

The GUIs can be rendered on display devices and can include data output areas to display information to the users as well as data entry areas to receive information from the users. For example, data output areas of the GUIs can output information associated with projects, bids, companies, vendors, suppliers, project owners, invoices, and/or any other suitable information to the users via the data outputs and the data entry areas of the GUIs can receive, for example, information associated with user information (project owner, vendor, supplier, administrators, etc), projects, bids, invoices, companies, and any other suitable information from users. Some examples of data output areas can include, but are not limited to text, graphics (e.g., graphs, maps (geographic or otherwise), images, and the like), and/or any other suitable data output areas. Some examples of data entry fields can include, but are not limited to text boxes, check boxes, buttons, dropdown menus, and/or any other suitable data entry fields.

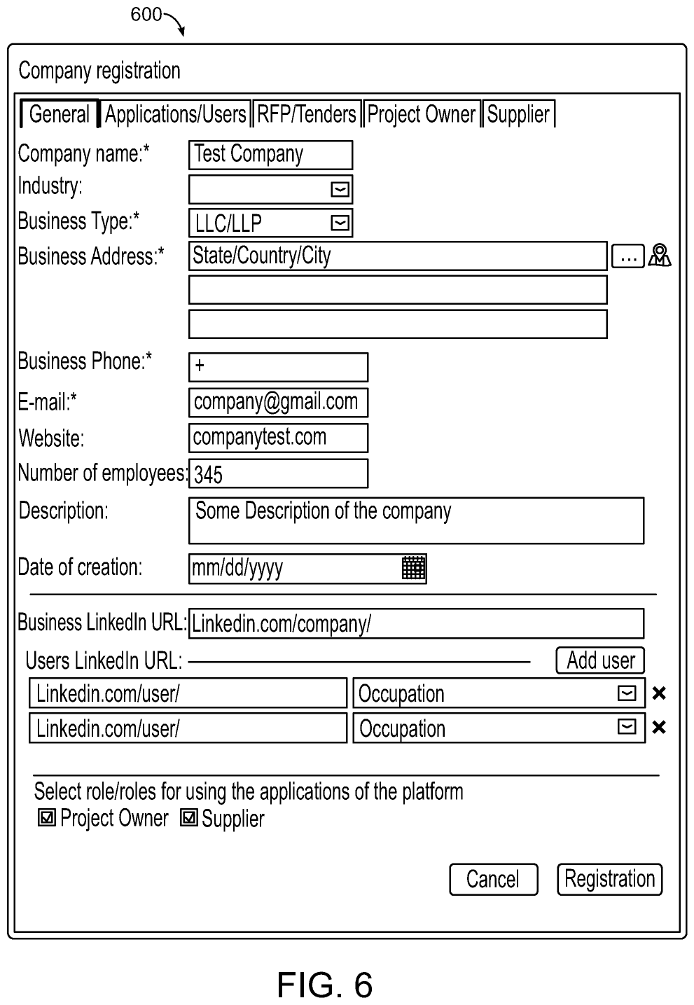

The process of registering a company via the SMB portal 110 of the collaborative, multi-user platform 100 can include creating a “main object” on the collaborative, multi-user platform that corresponds to the company. An Administrator or a representative of the company can register the company on the platform via the SMB portal 110.
1. As the first step, the main data of the company can be filled in. Also, a LinkedIn links to the company and users within the company can be input. The main data can be used to facilitate integration with LinkedIn and can simplify the process of the filling in the registration form and collecting data for Pre-Bid reports.
2. Then the role to using the platform should be selected (can choose one/both roles, see FIG. 6):
   Project Owner—global role for working with applications on the platform as Project Owner.
   Supplier—global role for working with applications on the platform as supplier.
2.1 If Project Owner role was selected, then the “Project Owner” tab appears with set of fields to be filled.
2.2 If Supplier role was selected, then the “Supplier” tab appears with set of fields to be filled.

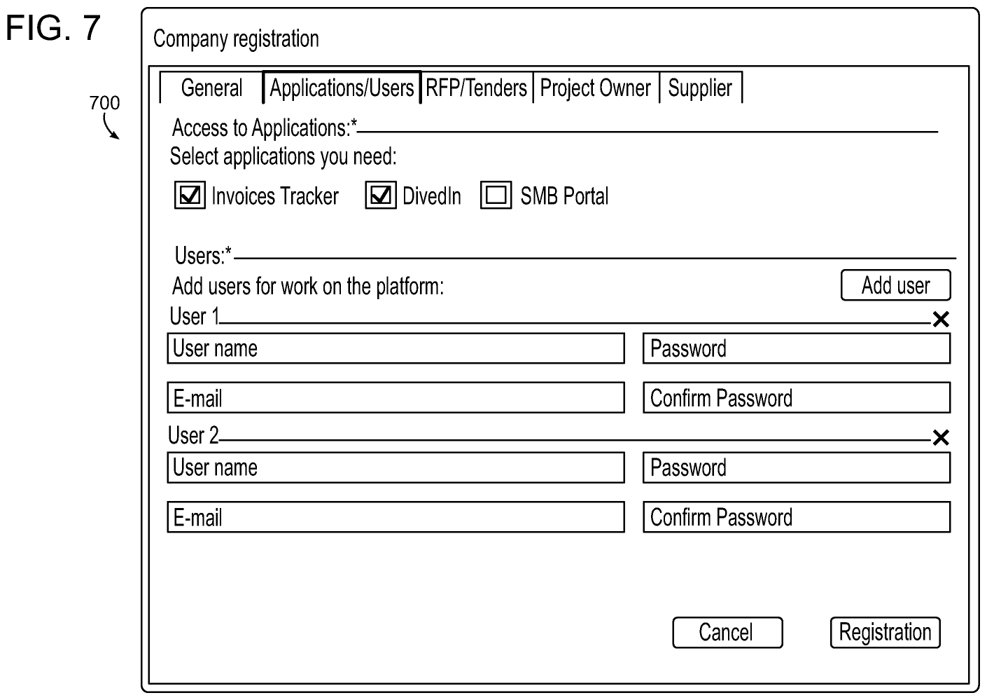

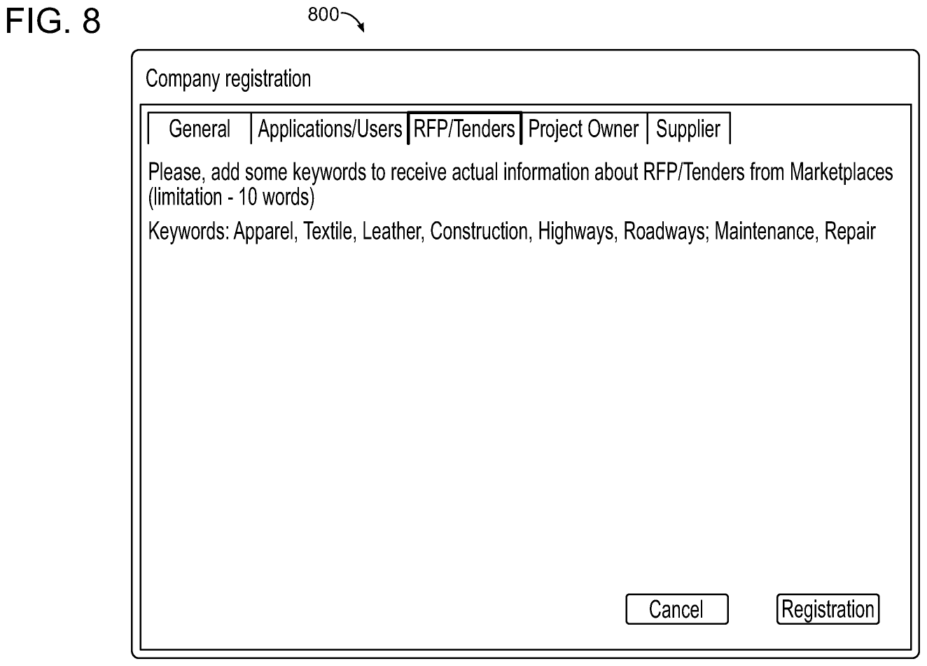

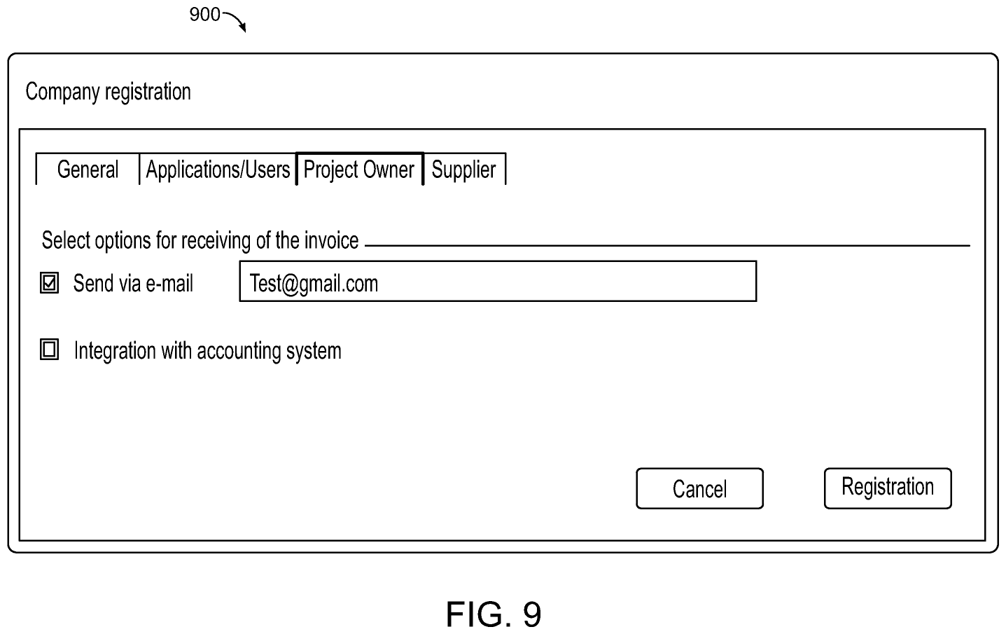

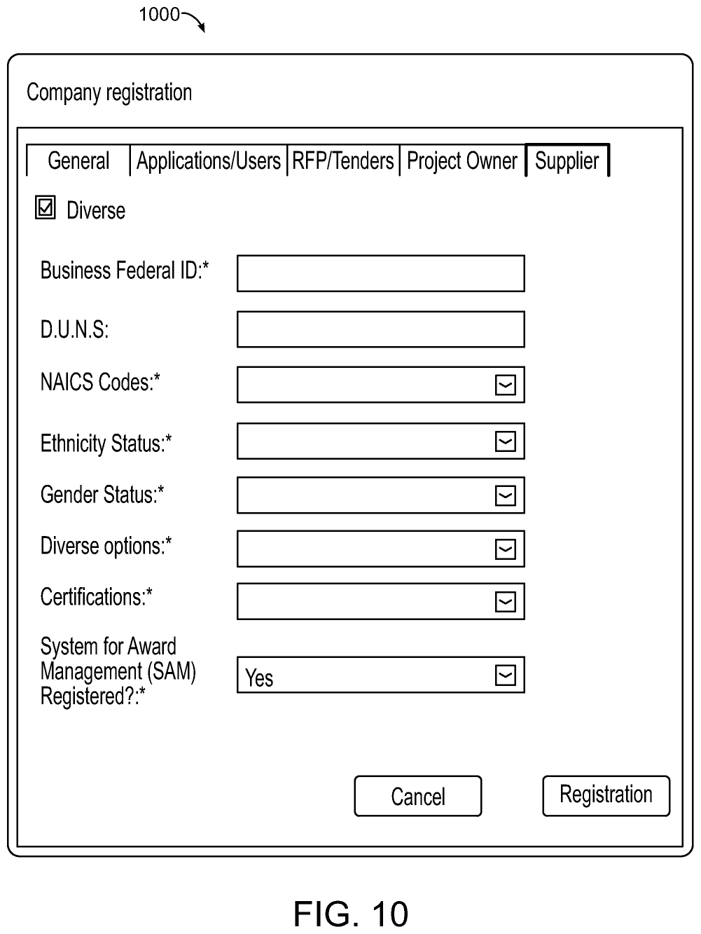

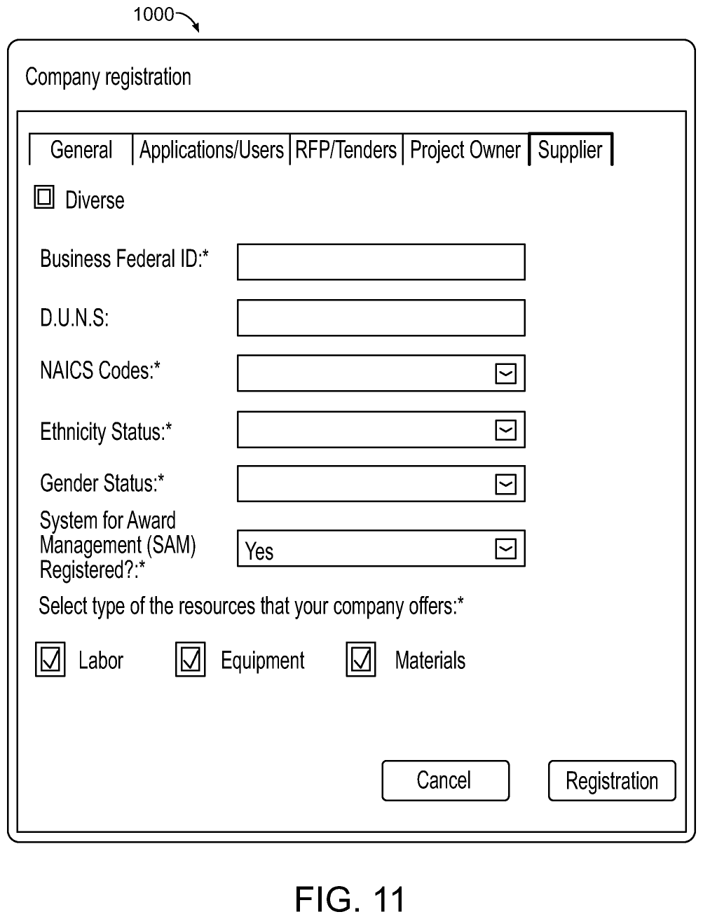

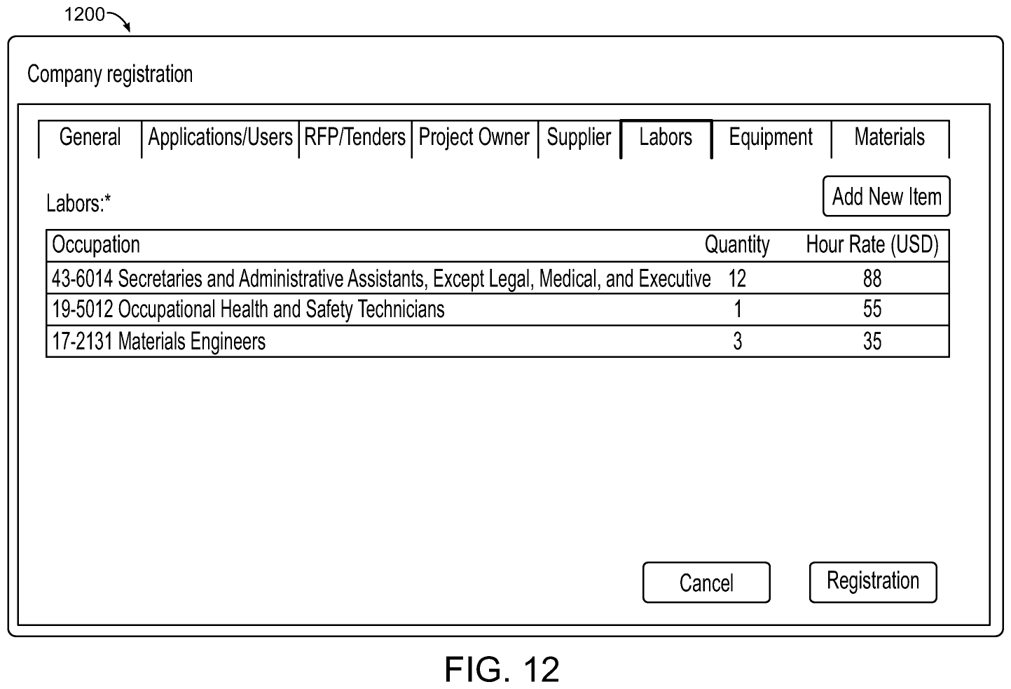

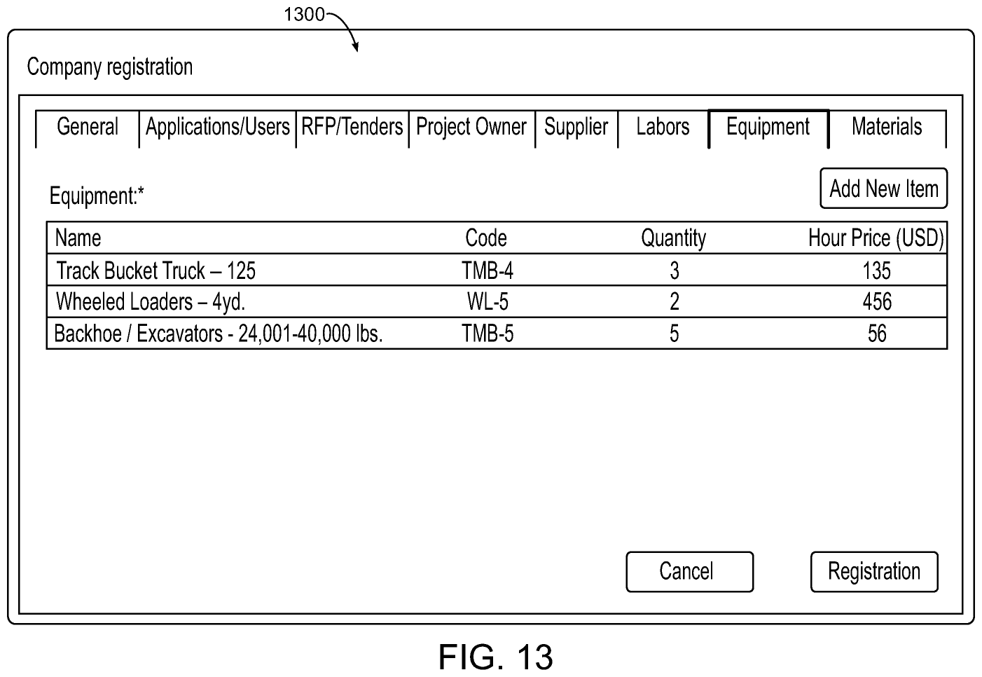

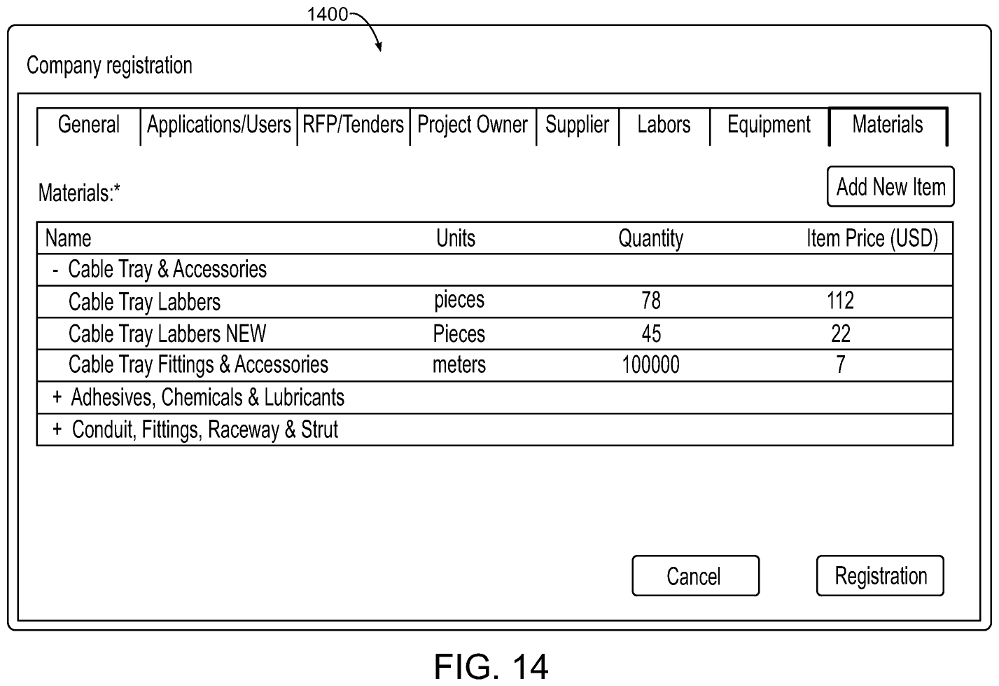

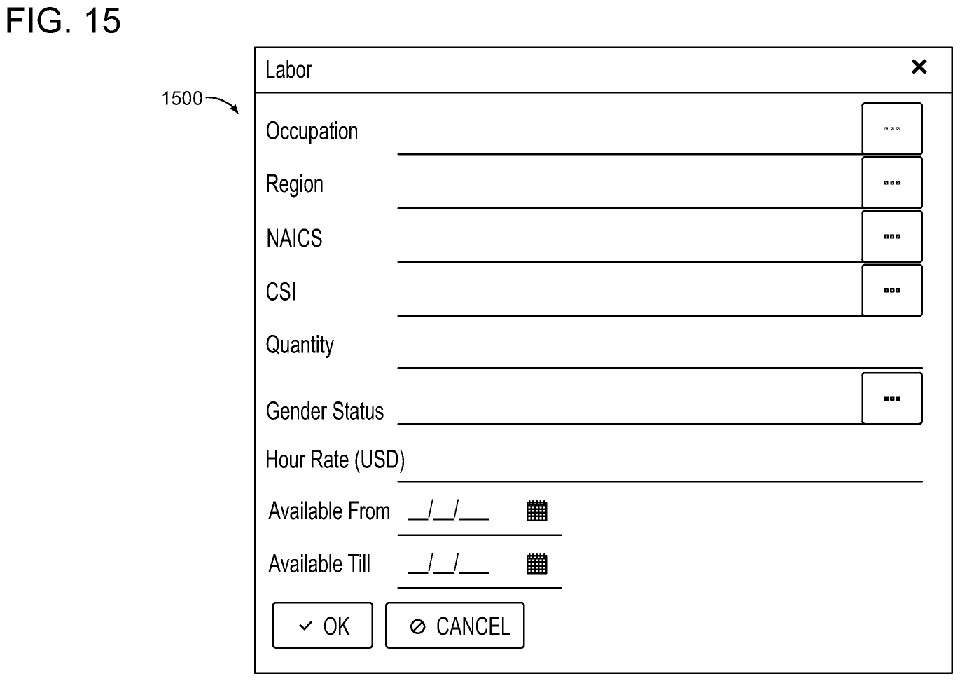

3. Next step—selection of applications that the company plans to use (see FIG. 7). For example, the SMB portal 110 and Diversity Planning and Team Optimizer subsystem 120 can be active to select, if the Project Owner/Supplier role was selected, and/or Invoices Tracker.
4. Then, a list of users can be created. If users are not added, company representatives will not have the access to the applications of the platform (see FIG. 7).
5. Keywords can be added to receive actual information about RFP/Tenders from Marketplaces. If the keywords have been added during the registration process of the company, the user can receive actual, curated information about RFP/Tenders announcements based on the keywords. If the keywords have not been added, the user can receive actual information for new RFP/Tenders (see FIG. 8).
6. Attributes on the “Project Owner” tab can be filled in, if necessary (see FIG. 9).
7. Attributes on the “Supplier” tab can be filled, if necessary. A set of fields in the supplier tab can depend on the type of resources the company provides:
7.1 If company is registered as a diverse supplier (with certification and a member of a diverse group), the “diverse” item can be selected (see FIG. 10). If a company is not registered as a diverse supplier (not certified and does not belong to diverse group), the “diverse” item should not be selected (see FIG. 11).
7.2 Also, company representative can select which resources their company provides, e.g., labor and/or equipment or materials (one/several options can be selected). Additional tabs, such as the following, can also appear (see item):
   “Labor” tab (see FIG. 12);
   “Equipment” tab (see FIG. 13);
   “Materials” tab (see FIG. 14).
If one of the options is not selected, the additional tab for filling in is not rendered in the graphical user interface.
8. Information about resources the company provides can be added (Labor/Equipment/Materials, see FIGS. 15-17).
9. After one or more of the preceding steps are complete, the process of registering the company can be finished. A company representative can change any profile information at any time.

The platform 100 can be integrated with the “Microsoft Teams” tool from Microsoft, Inc., which can be used for communication between potential project participants, project participants at all project stages, including a project creation stage by project owner.

The transition from platform 100 to Microsoft Teams and back can be initiated through special links within each subsystem of the platform 100. Communication groups in Microsoft Teams can be formed automatically in stages during the transition of a project. The platform 100 creates/updates a group chat, selecting suppliers based on resources added to the project/Digital Content Keywords. If a supplier is included in the group, then the supplier can access the group chat. The supplier can log out from the group chat if he is not interested in the project.

The stages of the automatic formation of the group in Microsoft Teams can provide that:
1. The Project Owner creates and saves a Project with the Digital Content Keywords. A group chat is created based on the entered Digital Content Keywords, i.e., a group chat with the potential suppliers will be formed depend on the entered Digital Content Keywords. The Project Owner can present his own project in this group chat and collects statistics via the survey of the participants (who are interested in this project).
2. The Project Owner decides to go to the tender, updates the data of the project/resources and necessary quantity, if it needs and saves the project—previous group chat is updated according to updated data of the project. At this stage, the Project Owner can announce tender in the group chat.
3. The Prime Vendor begins to plan the resources and launches “Team Optimizer”—the group chat is created where Prime Vendor discusses the project with other Suppliers and collects statistics via the survey of the participants (who are ready to participate in the project).
4. If the tender is won, the Prime Vendor updates resources before the start of the project—the previous group chat is updated according to updated resources.

Within the groups of the project, that were created automatically, via the platform 100, the following actions should be inactive:
Remove/change data group;
Add external users to the project group.

To create a project the “Project Owner” role should be selected and users should be indicated in the company registration process. The creation of the project is the main step for the Project Owner on the platform 100, because all working process closely connected with “Project” entity. Each project should have unique name and ID and could be tagged to easily search the project in the list.

Within each project the following abilities can be provided:
Request management (creation, approval, rejection via the Diversity Planning and Team Optimizer subsystem 120)—available between the Prime Vendor and the Suppliers.
Invoices management (creation, sending, payment, etc., via the Invoice Tracker subsystem 130)—available between the Project Owner and the Prime Vendor and also, between the Prime Vendor and the Suppliers.
Resources management (adding, changing, etc., via the Diversity Planning and Team Optimizer subsystem 120)—available for Prime Vendor.

Project Stages/Phases definition for embodiments of the present disclosure can be based on Project Management Institute (PMI) industry best practices definitions:
Initiation Phase—this is the phase where Project Owner initiates and creates projects on the platform 100. The project module and SMB portal 110 can be used during this phase.
Planning Phase—this is the phase where project owner or prime vendor start planning of project resources and/or supplier diversity planning using the DivedIn subsystem 120. This phase also include the tendering/bidding and proposal preparation and submission processes. The DivedIn subsystem 120 and SMB Portal 110 can be used during this phase for registration, sourcing, procuring, vetting, team collaboration, resource planning, supplier diversity planning, bidding, etc.
Execution Phase—this is the phase after the conclusion of pre-bid, bidding, proposal submission and contract award, and the starting of the post-contract award workflow that included notice to proceed (NTP), mobilization, project kick-off, etc. DivedIn module 120 and invoice tracker 130 can be utilize during this phase. For example, the planned project monthly cash flow and invoice are projected from start to the end of the project using the invoice tracker 130.
Control/Monitoring Phase—this is the phase where the projects on the platform 100 are being track, control and monitor for actual performance against set project goals and objectives. The invoice tracker 130 and DivedIn subsystem 120 can be utilize during this phase.
Close-out Phase—this is the phase where the project is completed. This phase include project close-out reports, final invoice, project post mortem/lesson learned work shop, project punchlist items, project commissioning, project operation manual, contractor/vendor/supplier demobilization, etc. The invoice tracker 130 DivedIn subsystem 120 can be utilize during this phase to create various close-out reports.

Project Owner story is the following:
1. Create the project with preliminary list of resources and quantity (maybe using template for project creation in future), if he/she has information about it. Otherwise, the Prime Vendor can create the base resources list with necessary quantity for each position after the Project Owner creates the project.
2. Create communication channels in Microsoft Teams.
3. Communicate with Suppliers.

Supplier/Prime Vendor story is the following:
1. View list of the Project Owner's projects.
2. Resources planning, both manually and through “Team Optimizer”.
3. Resources management (add new, remove, change current data).
4. Requests management (send request to the Diverse Suppliers for approve/reject resources).
5. Generation the Pre-Bid Report.
6. Start/Finish a project workflow.
7. Create communication channel in Microsoft Teams.
8. Manages invoices by the approved projects.

The invoice tracker subsystem 130 can increase transparency of invoicing/payment process and allow budget and cash flow planning. This can be achieved by establishing information exchange between Project Owners and Suppliers where they can share invoice details including dates and statuses. The Invoices Tracker takes within a specific project via the approved request from the Supplier.

To work with invoice tracker subsystem 130, as Project Owner, the company must be registered with global “Project Owner” role, the invoice tracker subsystem 130 should be selected, users are indicated and project is created.

Provided, that the Project Owner role is selected, the fields to be filled in appear (see FIG. 9). The following options for received Invoices can be provided in the Project Owner data filling form:
Send via e-mail—e-mail with invoice's link will be sent via Project Owner's e-mail that was added. The Invoice can be opened via link from the e-mail.
Integration with accounting system—This option will be active only for “Whitelabel” model when clients will use the platform 100 as their internal automation tools. Invoice will send to the accounting system with which the platform is integrated.

Only one of the options can be selected. If one of the options is not selected, an invoice will be sent via application only (standard option).

To work with the invoice tracker subsystem 130 as Supplier/Prime Vendor, the company must be registered with global “Supplier” role, the invoice trackers subsystem 130 should be selected, users are indicated.

Provided, that the Supplier role is selected, the fields to be filled in appear (see FIGS. 10-11)

The process of interaction between users, Prime Vendor and Supplier within the invoice tracker subsystem 130 can be the same as between Project Owner and Prime Vendor described herein.

Invoice statuses can include the following:
Planned—invoice planned by Supplier/Prime Vendor to be paid in future by Project Owner/Prime Vendor (default status on invoice registration). So, Supplier/Prime Vendor can plan (create) several invoices for different periods in the future.
Billed—invoice is “active”, waiting for payment (set manually by the Supplier/Prime Vendor once invoice sent to the Project Owner/Prime Vendor for payment);
Paid—invoice has been paid but Supplier/Prime Vendor has not received payment yet (set manually by the Project Owner/Prime Vendor once invoice has been paid);
Received—Supplier/Prime Vendor has received payment, invoice is “closed” (set by the Supplier/Prime Vendor manually once he receives payment);
Expired—Project Owner/Prime Vendor failed to pay invoice on time (this status system will set automatically);
Rejected—Project Owner/Prime Vendor failed to pay invoice because Supplier/Prime Vendor invoice paperwork is not correct;

Project Owner story can include the following:
1. View list of all invoices (registered by Prime Vendor) by their statuses;
2. Print an Invoice using default template (see FIG. 26);
3. Upload an Invoice using default template (see FIG. 26);
4. View graph of invoices data by time period and invoice status;
5. Change invoice status:
   a. From Billed to Paid—once particular invoice from Prime Vendor has been reviewed for payment;
   b. From Billed to Reject—once particular invoice from Supplier has been reviewed for rejection; If Invoice was rejected, the comment explaining the refusal/giving some recommends should be added.

Prime Vendor story can include the following:
1. Register all planned invoices (invoice details could be changed until Billed Invoice);
2. View it's invoices for all Project Owners and Projects;
3. View list of all invoices (registered by Suppliers) by their statuses;
4. Print an Invoice using default template (see FIG. 26);
5. Upload an Invoice using default template (see FIG. 26);
6. View graph for planned cash flow;
7. View graph for invoices by statuses;
8. Change invoice status:
   a. From Planned to Billed—once invoice issued and sent to Project Owner;
   b. From Billed to Paid—once particular invoice from Supplier has been reviewed for payment;
   c. From Billed to Reject—once particular invoice from Supplier has been reviewed for rejection; If Invoice was rejected, the comment explaining the refusal/giving some recommends should be added.
   d. From Billed to Received—once he receives payment;

Supplier story can include the following:
1. Register all planned invoices (invoice details could be changed until Billed Invoice);
2. View it's invoices for all Project Owners and Projects;
3. Print an Invoice using default template (see FIG. 26);
4. Upload an Invoice using default template (see FIG. 26);
5. View graph for planned cash flow;
6. View graph for invoices by statuses;
7. Change invoice status:
   a. From Planned to Billed—once invoice issued and sent to Prime Vendor;
   b. From Billed to Received—once he receives payment from Prime Vendor.

The Diversity Planning and Team Optimizer subsystem 120 can allow corporations (GA, PC, F5H) to make informed decisions on Supplier Diversity level they can achieve for a particular project/supply chain spend. The goal achieved by supply chain resource planning based on Diverse/Non-Diverse resources availability database so that at the end of planning process Supplier Diverse/Non-Diverse level can be calculated automatically.

To work with Diversity Planning and Team Optimizer (DivedIn) subsystem 120, the company can register with global roles (Project Owner and Supplier), the Diversity Planning and Team Optimizer subsystem 120 can be selected, users can be indicated, and a project can be created.

Provided, that the roles of Project Owner/Supplier and the Diversity Planning and Team Optimizer subsystem 120 application are selected during the company registration process, the tabs with sets of the attributes to be filled in appear (see FIGS. 9-11).

When the a new Project Owner starts the platform 100 for the first time, the Project Owner should fill in a list of required resources and necessary quantities—if the information is available. Otherwise, the Prime Vendor can create the base resources list with necessary quantity for each position after the Project Owner creates the project. But in this situation each Prime Vendor who wants to tender can have his own base resources list.

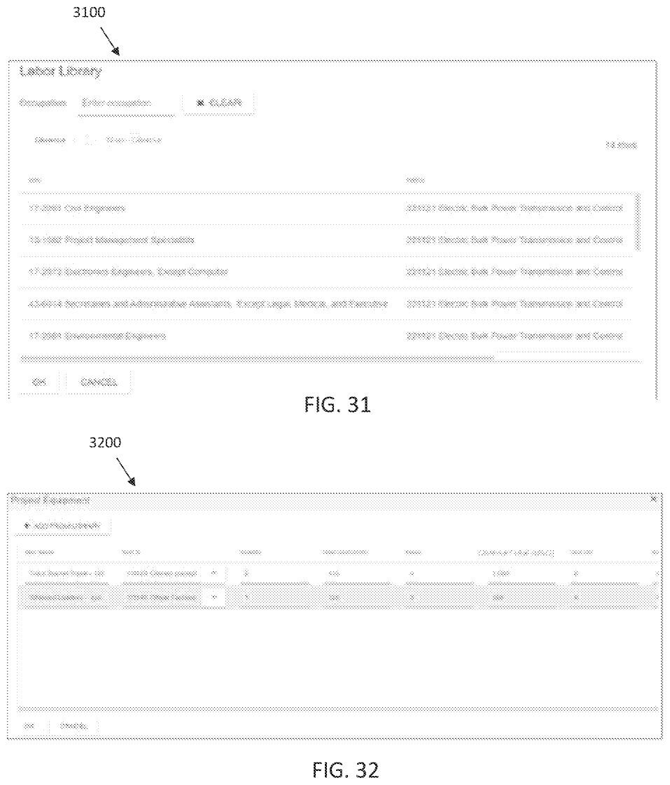

Before and after the Prime Vendor is selected via the platform 100, the Project Owner begins to plan the project resources. This process can be manual and automated. When adding resources manually, the type of resource providers, Diverse or Non-Diverse, should be determined by switching the slider to the desired position (see FIGS. 31, 33, and 35).

Then, the automatic recruitment of the resource provider can be launched by “Optimize team” button. The message “You want to update all resource list or positions without data only?” can be displayed. After selection of the necessary option, the “Optimize team” process can be launched.

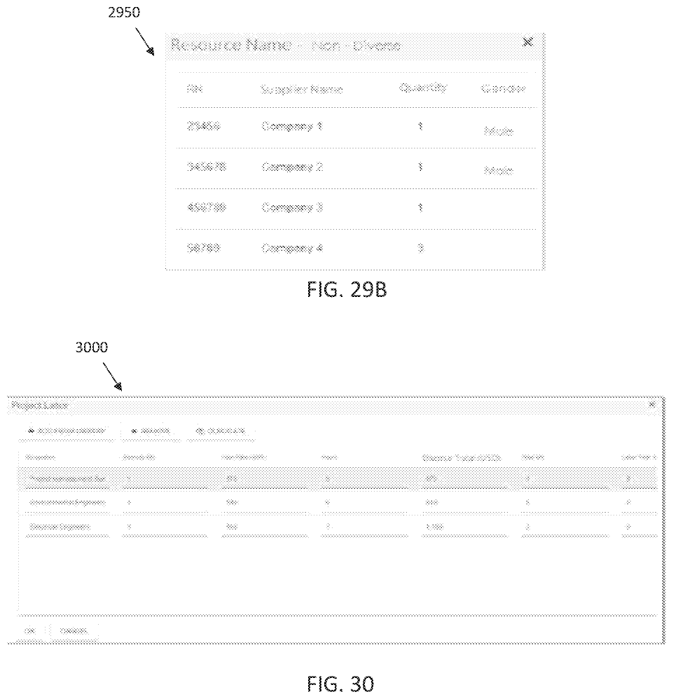

After the Prime Vendor selection process is finished, the platform can offer an appropriate amount of resources for each position (labor, equipment, materials), both for Diverse resources and for Non-Diverse. The data for each position (labor, equipment, materials) may change according to Prime Vendor needs or requirements. Numbers in rows are showing number of resources found. If number is green—all needed resources are found. If it is red—only part of needed resource are found. The ability to view provided quantity of the resources by each Suppliers can be provided by clicking on the quantity in the list. A list of the Suppliers with short information about company and quantity of the resources can be displayed (see FIGS. 29A-B). The Prime Vendor can add/change resources at every stage of the project, except for completed projects.

A project can include the following stages:
1. Initiation stage—project creation by Project Owner.
2. Planning stage—planning of the resources of the project (including Diverse resources).
3. Tender stage—stage after Pre-Bid report generated and tender application sent.
4. Working stage—stage after the conclusion of contracts and the starting of the workflow.

If the resources were changed by a Supplier (Supplier can change resources via «Personal area»), already selected resources can be updated automatically for the project by the platform. Also, Prime Vendor can add, change, or remove resources manually.

Prime Vendor can send requests to Suppliers from which resources planned to be used and after confirmation, the Project Owner starts a workflow. All changes of the already selected resources cannot be changed automatically in the Project Owner's project. There is an ability to change the resources after start of the project by the Prime Vendor, but these changes also can be regulated by contract between Prime Vendor and Supplier.

At a close-out stage (when the project is completed), the Prime Vendor completes a workflow. Resources cannot be changed automatically in the project. There is no ability to change the resources after a project is complete.

Project Owner story can include the following:
1. Add resources list with necessary quantity to the project.

Supplier/Prime Vendor story can include the following:
1. Resources planning (Diverse/Non-Diverse) both manually and automatically via Team Optimize.
2. View Diverse resources availability by Labor, Equipment and Materials in Project Region;
3. View Diverse/Non-Diverse resources within the Suppliers, who provide resources for the project by clicking on the quantity in the list.
4. View all Project resources with their quantity, daily rate, total cost and diverse information for every resource (quantity and total cost);
5. View Total Project's resources quantity/cost, total Diverse resources quantity/cost;
6. View Diverse resources percent (quantity, cost) from the overall budget of the project on the graphs;
7. Generate Pre-Bid Report;
8. Send request to the Suppliers for approve/reject resources to making a decision to start a project Diversity Planning and Team Optimizer subsystem 120). The Supplier itself can track its resources and can understand to whom the Supplier can confirm and to what period;
9. Start/Finish a project workflow;
10. View list of the contracts by the project with ability to see the details of the contract by the link; and
11. View History of the changes of the Diverse resources.

Resources changes that were made after start of the project should be displayed in the History of the changes.

The following actions that were made with resources after a start of a project can be displayed in the list of the History:
Changed—some resource's attributes were changed;
Added—new resource (Labor/Equipment/Materials) was added;
Removed—some resource was removed.

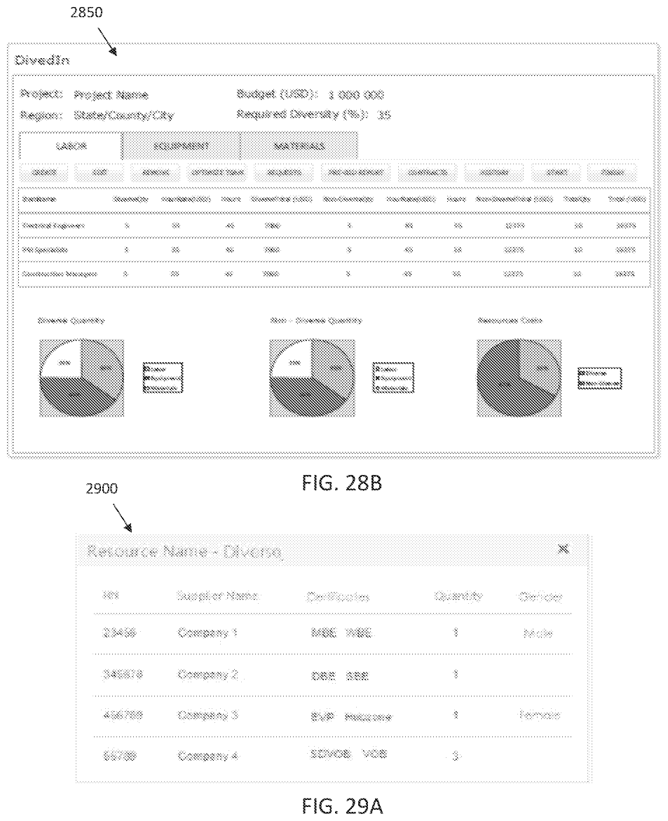

Resource changes that were made after start of the project can also be shown on a main graphs (see FIG. 28).

The platform 100 can be integrated with the LinkedIn™ social network to simplify the process of the filling in of the registration form and collecting the data for the “Pre-Bid Report”.

Any company and individual professional data that are freely and publicly available can be collected by the platform 100 from LinkedIn.

The following company data (see table below) can be determined for integration from LinkedIn to the platform 100. The table shows the correspondence of the LinkedIn data and the fields of data in the platform 100 such that the LinkedIn data can be integrated into the platform 100.

| LinkedIn | Platform, 100 |
|---|---|
| Name | Company Name |
| Overview | Description |
| Website | Website |
| Company Size | Number of employees |
| Industry | Industry |
| Founded | Date of creation |
| Company Type | Business Type |
| E-mail | E-mail |
| Phone | Business Phone |
| Business public URL | Business LinkedIn URL |
| Location/Headquarters | Business Address |

The following individual data of users of the platform 100 can be determined for integration from LinkedIn to the platform 100: Experience, Education, Licenses and Certifications, Skills, Accomplishments (Causes, Languages, Projects). The individual data can be copied if the LinkedIn link of the user has been filled in in the platform 100. In some embodiments, the data can be combined and displayed in a Pre-bid report.

The platform 100 can be integrated with the “B2B2G Marketplaces” to connect with sources for RFP/Tenders.

As non-limiting example, the platform 100 can integrate or otherwise access the following big data sources:
US Govt Contract Opportunities—beta.sam.gov
NY State Contract Reporter—nyscr.ny.gov
City of Philadelphia: eContract Philly secure.phila.gov/ECONTRACT/default.aspx
B2GNOW—b2gnow.com•Nigeria Govt—Bureau of Public Procurement—bpp.gov.ng
Nigeria Govt—Nigerian Content Development and Monitoring Board —ncdmb.gov.ng
US Govt—Beta.SAM.Gov

The data by “RFP/Tenders” announcements can be stored in a database of the platform 100. The quantity of data depends on the source and/or capabilities APIs for integrating or accessing the data. The data from the source can be integrated into the platform 100 hourly, daily, weekly, monthly, or at any suitable frequency.

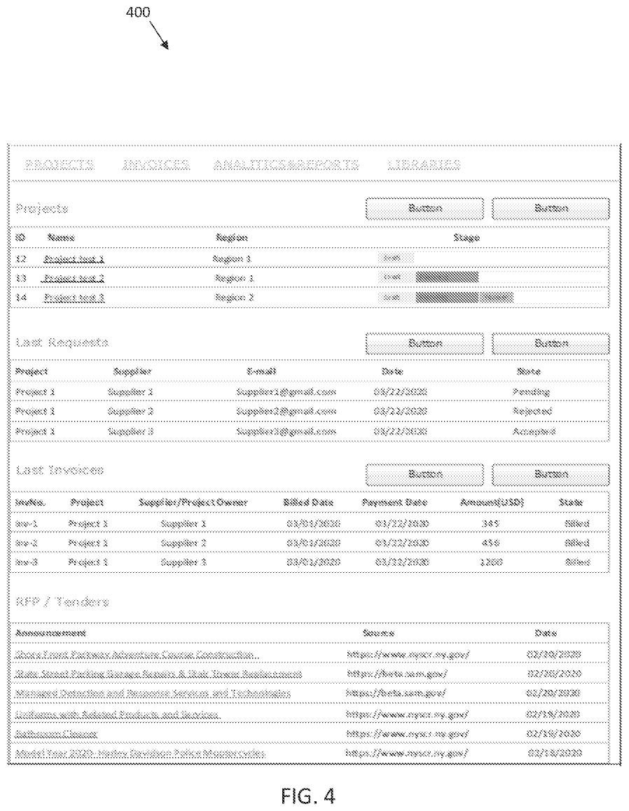

The list of the “RFP/Tenders” links (with source and date) of the last announcements can be displayed on the user's SMB portal 110 (see FIG. 4). If the keywords have been added by the user during the registration process of the company, the user can obtain actual information about RFP/Tenders announcements according to the keywords. If the keywords have not been added, the user can obtain actual information by all new RFP/Tenders (see FIG. 8).

Links to RFP/Tenders can be sorted by date (from late to early). The detailed form of the announcement with information about a specific RFP/Tender can be opened by clicking on a corresponding link. The “RFP/Tenders” group can be created automatically in “Microsoft Teams” messenger within the first integration. The links to RFP/Tenders announcements can be placed in the format: “New RFP/Tenders from <site name> by link <link to RFP/Tenders>” in this group. New announcements can be placed in the Microsoft Teams group regardless of the keywords. Registered users can have access to this chat within Microsoft Teams without an ability to send any comments. The detailed form of the announcement with information about a specific RFP/Tender can be opened by clicking on the link.

The ability to create some of the reports by specific project via the AI Data Analytics and Reporting subsystem 150 appears after start of the project. The creation of the report by specific project is not active before the start of the project.

On this stage three reports can be identified:
Diverse Report—the Diverse resources at the start of the project and current time/after the completion of the project will be presented (depend on the report's time).
General resource report—data by all resources at the start of the project and current time/after the completion of the project will be presented (depend on the report's time).
Project finance report—data by all finance operations within the “Invoices Tracker” system, indicating the status of the account, amount, supplier and purpose of payment.

After the report is formed user can save/print/send it.

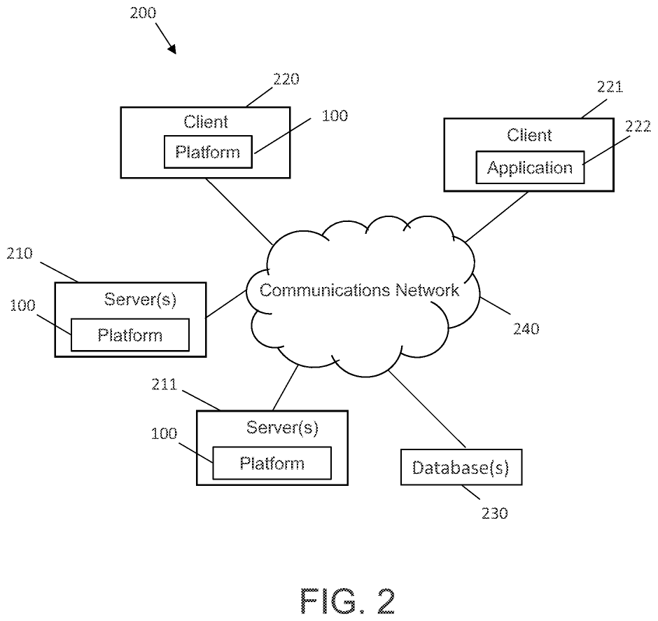

FIG. 2 depicts exemplary environments 200 for implementing embodiments of the collaborative, multi-user platform 100 in accordance with embodiments of the present disclosure. As shown in FIG. 2, the environment 200 can include servers 210-211, client device 220-221, and repositories (or databases) 230, which can be operatively coupled to each other via a communication network 240. The communication network 430 can be implemented as an Intranet, virtual private network (VPN), wide area network (WAN), local area network (LAN), and/or other suitable communication network.

Any one of the servers 210-211 can be programmed to implement one or more components of the platform 100 or portions thereof including embodiments of the SMB portal 110, the 120, the 130, the 140, and/or the 150 shown in FIG. 1. In some embodiments, particular servers can be programmed to implement particular portions of the platform 100 such that the group of server is collectively programmed to implement embodiments of the platform 100 (e.g., the server 210 can execute instances of the SMB portal 110; and the server 211 can implement instances of the one or more of the other subsystems of the platform 100).

The client devices 220-221 can be operatively coupled to the severs 210-211 via the communication network 230 to interface and interact with the platform. In some embodiments, the client devices 220-221 can implement the platform 100 or portion thereof and/or can implement a client side application 222 (e.g., an application specific to the platform 100 or a web browser) for interfacing and interacting with the platform being executed by the servers 210-211.

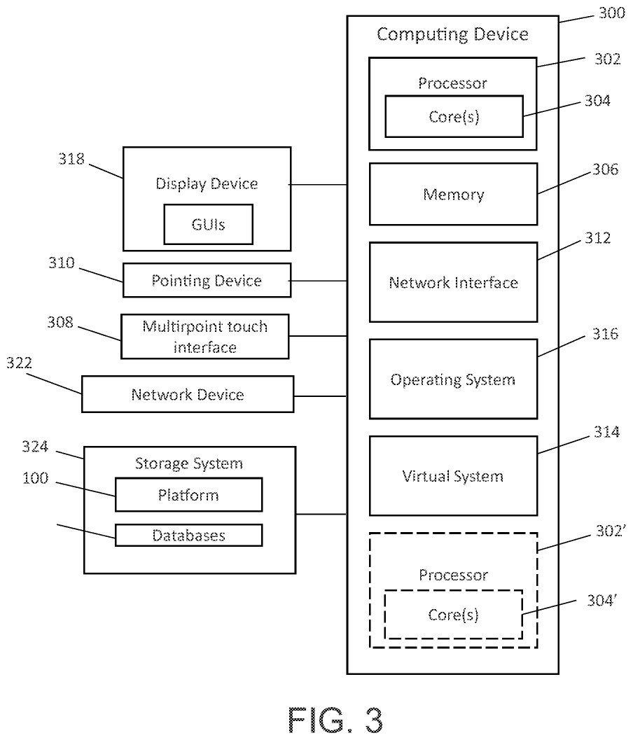

FIG. 3 is a block diagram of an exemplary computing device 300 for implementing one or more of the servers 210-211 and/or client devices 220-221 in accordance with embodiments of the present disclosure. In the present embodiment, the computing device 300 is configured as a client-side device that is programmed and/or configured to execute one of more of the operations and/or functions for embodiments of the platform 100 described herein. The computing device 300 includes one or more non-transitory computer-readable media for storing one or more computer-executable instructions or software for implementing exemplary embodiments of the platform 100 described herein. The non-transitory computer-readable media may include, but are not limited to, one or more types of hardware memory, non-transitory tangible media (for example, one or more magnetic storage disks, one or more optical disks, one or more flash drives), and the like. For example, memory 306 included in the computing device 300 may store computer-readable and computer-executable instructions, code or software for implementing exemplary embodiments of the platform 100 or portions thereof.

The computing device 300 also includes configurable and/or programmable processor 302 and associated core 304, and optionally, one or more additional configurable and/or programmable processor(s) 302′ and associated core(s) 304′ (for example, in the case of computer systems having multiple processors/cores), for executing computer-readable and computer-executable instructions, code, or software stored in the memory 306 and other programs for controlling system hardware. Processor 302 and processor(s) 302′ may each be a single core processor or multiple core (304 and 304′) processor.

Virtualization may be employed in the computing device 300 so that infrastructure and resources in the computing device may be shared dynamically. A virtual machine 314 may be provided to handle a process running on multiple processors so that the process appears to be using only one computing resource rather than multiple computing resources. Multiple virtual machines may also be used with one processor.

Memory 306 may include a computer system memory or random access memory, such as DRAM, SRAM, MRAM, EDO RAM, and the like. Memory 306 may include other types of memory as well, or combinations thereof.

A user may interact with the computing device 300 through a visual display device 318, such as a computer monitor, which may be operatively coupled, indirectly or directly, to the computing device 300 to display one or more of graphical user interfaces that can be provided by the platform 100 in accordance with exemplary embodiments. The computing device 300 may include other I/O devices for receiving input from a user, for example, a keyboard or any suitable multi-point touch interface 308, and a pointing device 310 (e.g., a mouse). The keyboard 308 and the pointing device 310 may be coupled to the visual display device 318. The computing device 300 may include other suitable I/O peripherals.

The computing device 300 may also include or be operatively coupled to one or more The computing device 300 may also include one or more storage devices 324, such as a hard-drive, CD-ROM, mass storage flash drive, or other computer readable media, for storing data and computer-readable instructions and/or software that can be executed by the processing device 302 to implement exemplary embodiments of the platform 100 described herein. For example, the storage devices can store the platform and the one or more databases 230 for use with the platform 100 (e.g., storing supplier information, vendor information, diversity information, finance information, materials libraries and lists, resource libraries and lists, supplier libraries and lists, projects, and/or other data and information that can be used by the platform 100).

The computing device 300 can include a network interface 312 configured to interface via one or more network devices 320 with one or more networks, for example, Local Area Network (LAN), Wide Area Network (WAN) or the Internet through a variety of connections including, but not limited to, standard telephone lines, LAN or WAN links (for example, 802.11, T1, T3, 56 kb, X.25), broadband connections (for example, ISDN, Frame Relay, ATM), wireless connections, controller area network (CAN), or some combination of any or all of the above. The network interface 312 may include a built-in network adapter, network interface card, PCMCIA network card, card bus network adapter, wireless network adapter, USB network adapter, modem or any other device suitable for interfacing the computing device 300 to any type of network capable of communication and performing the operations described herein. Moreover, the computing device 300 may be any computer system, such as a workstation, desktop computer, server, laptop, handheld computer, tablet computer (e.g., the iPad™ tablet computer), mobile computing or communication device (e.g., the iPhone™ communication device), point-of sale terminal, internal corporate devices, or other form of computing or telecommunications device that is capable of communication and that has sufficient processor power and memory capacity to perform the processes and/or operations described herein.

The computing device 300 may run any operating system 316, such as any of the versions of the Microsoft® Windows® operating systems, the different releases of the Unix and Linux operating systems, any version of the MacOS® for Macintosh computers, any embedded operating system, any real-time operating system, any open source operating system, any proprietary operating system, or any other operating system capable of running on the computing device and performing the processes and/or operations described herein. In exemplary embodiments, the operating system 316 may be run in native mode or emulated mode. In an exemplary embodiment, the operating system 316 may be run on one or more cloud machine instances.

FIG. 4 depicts an exemplary graphical user interface 400 that can be generated by the SMB portal 110 of an embodiment of the collaborative, multi-user platform 100 to facilitate user/company registration. As shown in FIG. 4, the GUI 400 can identify projects identifiers, names, geographic regions, and a current stage and/or completed stages of the projects. The GUI 400 can show last requests for projects from suppliers and a status of the requests. The GUI 400 can also show invoices for projects from suppliers and a status of the invoice. The GUI 400 can also list available RFPs or tenders for projects and can provide links to the RFPs/tenders.

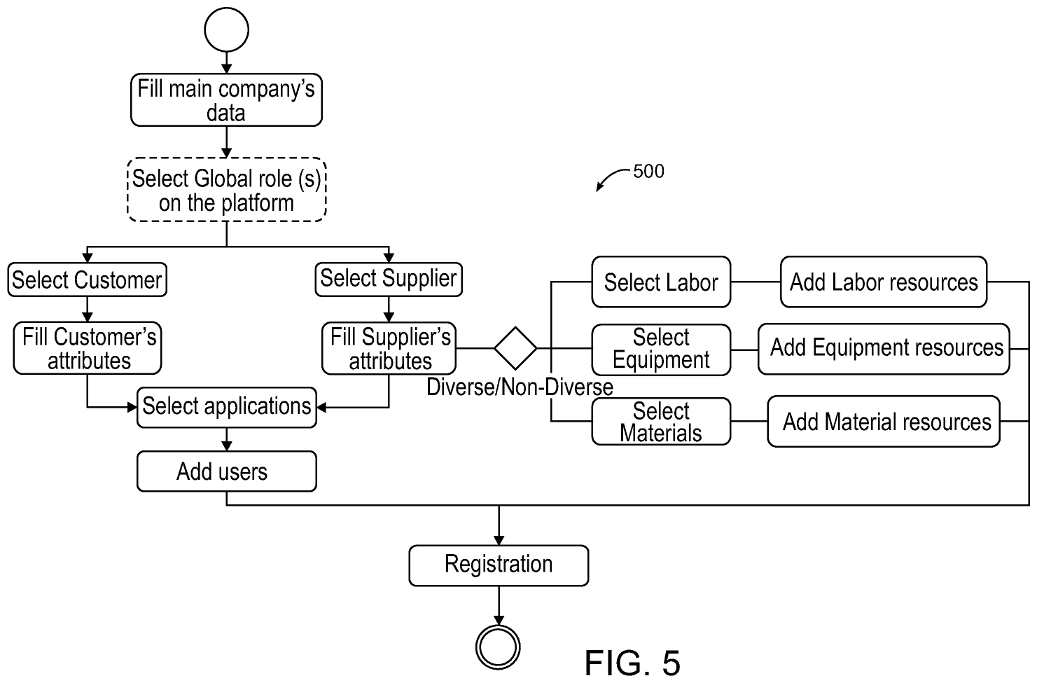

FIG. 5 depicts an exemplary flowchart illustrating a process 500 for registering a user/company in the collaborative, multi-user platform 100 via the SMB portal 110 in accordance with embodiments of the present disclosure. As shown in FIG. 5, the user can begin by entering data for the company, selecting one or more roles for the company (e.g., project owner, customer (supplier, vendor)), and filling in attributes and information. The user can also select which of the subsystems of the platform 100 will be used and adds users to the account for the company. The user can also specify resources associated with the company, such as labor, equipment, and/or materials.

FIG. 6-17 illustrate exemplary graphical user interfaces of the SMB portal 110 for an embodiment of the collaborative, multi-user platform for registering a company with the collaborative, multi-user platform.

As shown in FIG. 6, a GUI 600 can correspond to a selection of the “General” tab of the company registration process. The GUI 600 can include data entry fields for a company name, industry, business type, address, phone number, e-mail address, website (URL), a number of employees, a company description, and a date of incorporation/creation. The GUI 600 can also include data entry fields for the businesses LinkedIn page, and employee LinkedIn pages and can allow the user to select one or more roles for the company, such as project owner or supplier.

As shown in FIG. 7, a GUI 700 can correspond to a selection of the “Applications/User” tab of the company registration process. The GUI 700 can include data entry fields for selecting the subsystems of the platform 100 that the user will access, and to add authorized users to the platform 100.

As shown in FIG. 8, a GUI 800 can correspond to a selection of the “RFP/Tenders” tab of the company registration process. The GUI 800 can include data entry fields for receiving keywords from the user. The keywords can be used by the platform to automated searching and filtering of RFPs/Tenders for the user.

As shown in FIG. 9, a GUI 900 can correspond to a selection of the “Project Owner” tab of the company registration process. The GUI 900 can include data entry fields for an e-mail address at which the user will receive invoices and to allow the platform to integrate with the users accounting system.

As shown in FIGS. 10-11, a GUI 1000 can correspond to a selection of the “Supplier” tab of the company registration process. The GUI 1000 can include data entry fields for receiving a selection from the user if the supplier is a diverse supplier and/or to receive a business federal identifier, a DUNS, NAICS Codes, ethnicity status, a gender status, diverse options, certifications, and/or whether the use is registered for a system for award management (SAM). The GUI 1000 can also include data entry fields for selecting the type of resources the company offers (e.g., labor, equipment, materials).

As shown in FIGS. 12 and 15, a GUIs 1200 and 1500 can correspond to a selection of the “Labor” tab of the company registration process. The GUIs 1200 and 1500 can include data entry fields for receiving information about labor resources that the company can provide (e.g., occupation, quantity, and rate).

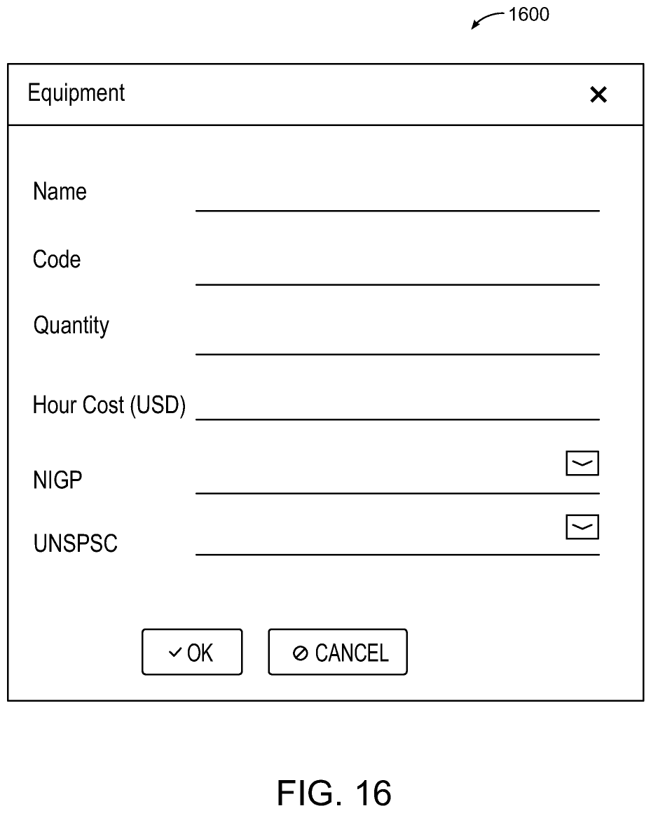

As shown in FIGS. 13 and 16, a GUIs 1300 and 1600 can correspond to a selection of the “Equipment” tab of the company registration process. The GUIs 1300 and 1600 can include data entry fields for receiving information about equipment resources the company can provide (e.g., name, code, quantity, and rate).

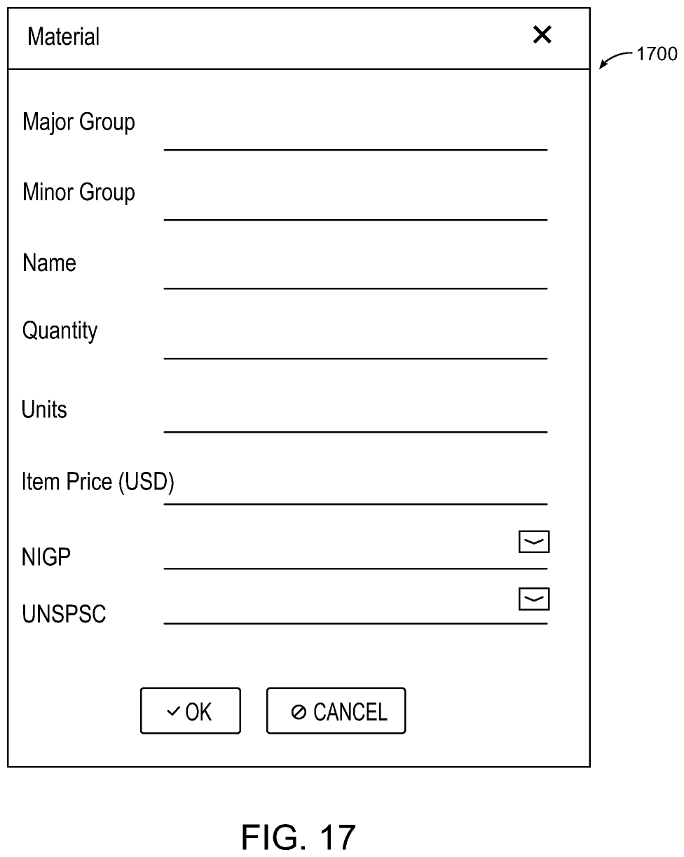

As shown in FIGS. 14 and 17, a GUIs 1400 and 1700 can correspond to a selection of the “Material” tab of the company registration process. The GUIs 1400 and 1700 can include data entry fields for receiving information about material resources the company can provide (e.g., name, units, quantity, and price).

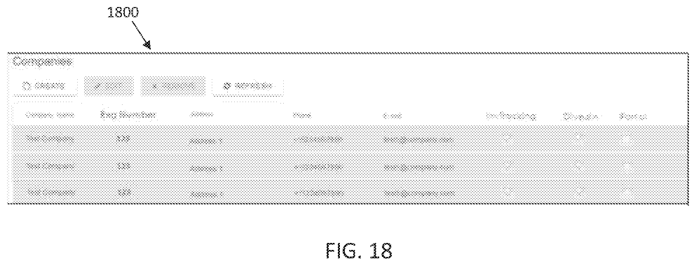

FIG. 18 is an exemplary GUI 1800 providing a list of companies registered on an embodiment of the collaborative, multi-user platform via the SMB portal 110.

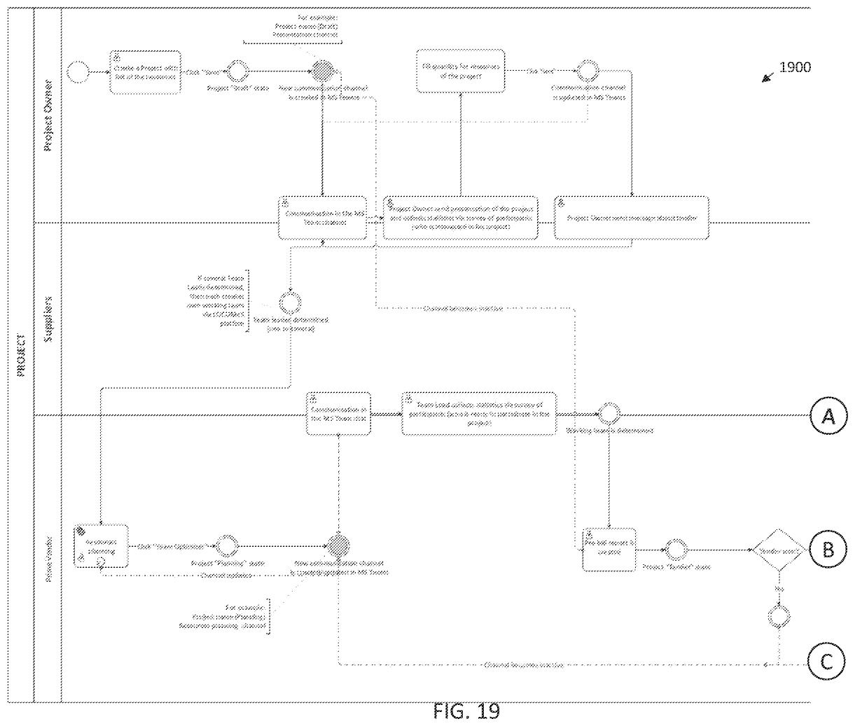

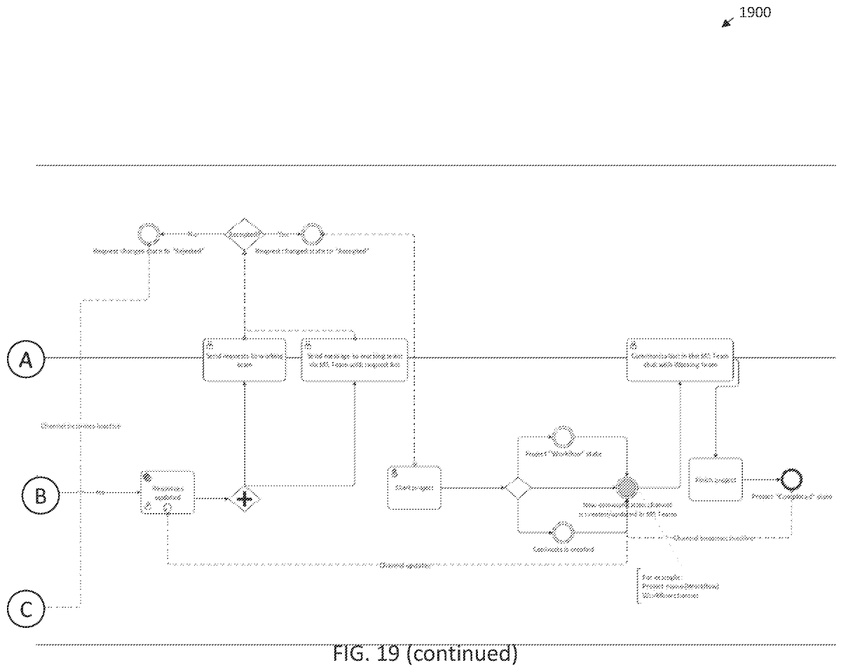

FIG. 19 is a flowchart illustrating an exemplary process 1900 for interaction between users, Project Owners, Prime Vendors and Suppliers within a defined “Project”. A project owner creates a project with a list of resources and saves the project. A new collaborative communication channel is established for the project (e.g., in Microsoft Teams) through which the project owner, supplier, and/or the prime vendor can communicate with each other, and one or more team leaders are determined. Via the collaborative communication channel, the project own transmits documents about the project and collects statistics from surveys of participants and fills in quantities for the resources need for the project and the project data is saved.

The prime vendor can initiate resource planning for the project and can create a new separate collaborative communication channel for resource planning via which the team leader(s) collect statistics from surveys of participants that are ready to participate in the project and a working team is identified. Subsequently, a pre-bid report is generated and a tendered is submitted. If the tender is not won, the communication channel created by the prime vendor becomes inactive and the prime vendor can re-submit a bid. If the tender is won, the resources are updated and messages and requests are sent via the communication channel to the working team and a bid is submitted to the supplier. If the supplier rejects the bid, the communication channel created by the prime vendor is deactivated. If the supplier accepts the bid, the project starts, the state of the project in the platform is updated, a project workflow for the project is created, and a contract for the project is created. Additionally, a new collaborative communication channels is created for the project. Once the project is completed, it is marked as “completed” in the platform and the communication channel for the project is deactivated.

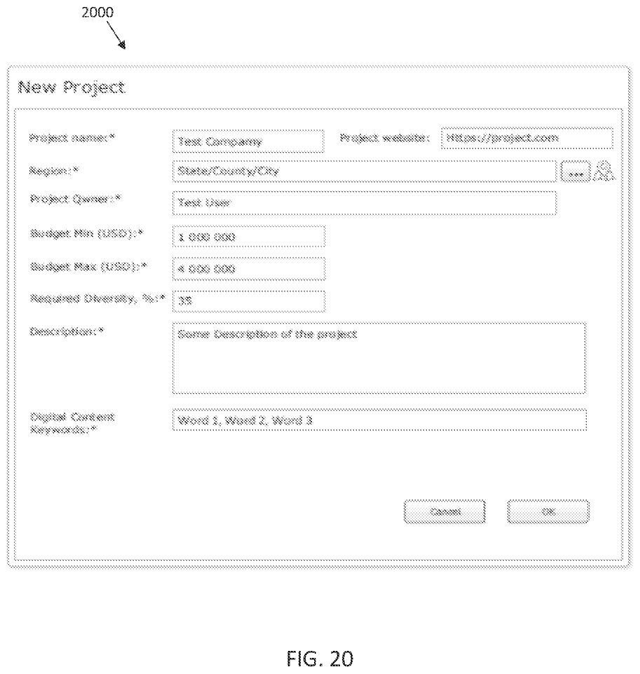

FIG. 20 depicts a GUI 2000 for creating a new project in an embodiment of the collaborative, multi-user platform 100. The GUI 2000 can include data entry fields for receiving new project information including, for example, a project name, a project website, a region, a project owner, a minimum budget, a maximum budget, a required diversity percentage, a project description, an/or keywords for the project.

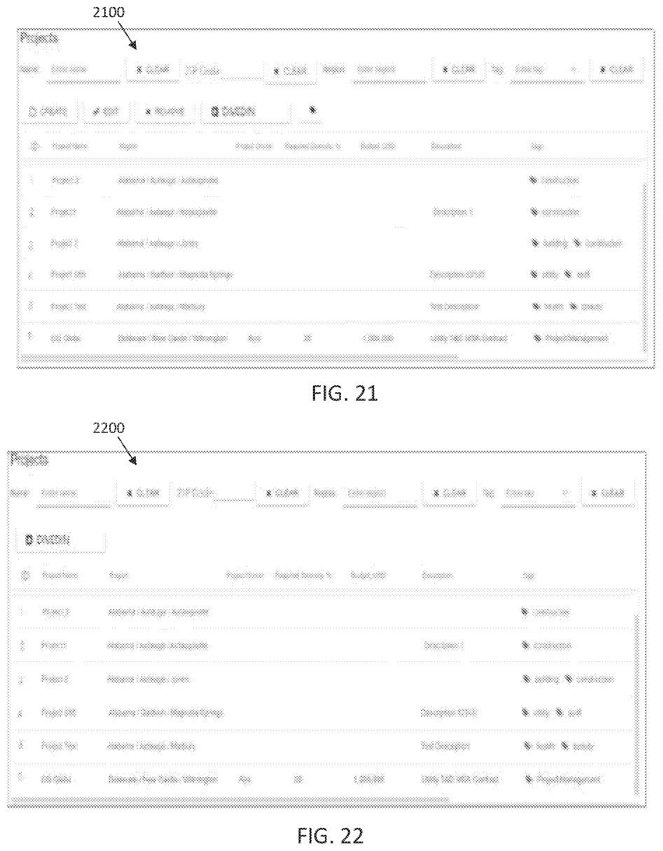

FIG. 21 depicts a GUI 2100 identifying existing projects created by a project manager in an embodiment of the collaborative, multi-user platform. The GUI 2100 can include a list of projects that have been generated and can include allow users to search for projects based on the project name, zip code, region, tag, and/or other information to query projects in the database(s). The GUI 2100 can include options for creating, editing, and/or removing projects as well as an option “DivedIn” which when selected causes the Diversity Planning and Team Optimizer subsystem 120 to be executed.

FIG. 22 depicts a GUI 2200 identifying existing projects for a supplier in an embodiment of the collaborative, multi-user platform. The GUI 2200 can include a list of projects that have been generated and can include allow users to search for projects based on the project name, zip code, region, tag, and/or other information to query projects in the database(s). The GUI 2100 can include an option “DivedIn” which when selected causes the Diversity Planning and Team Optimizer subsystem (or DivedIn subsystem) 120 to be executed.

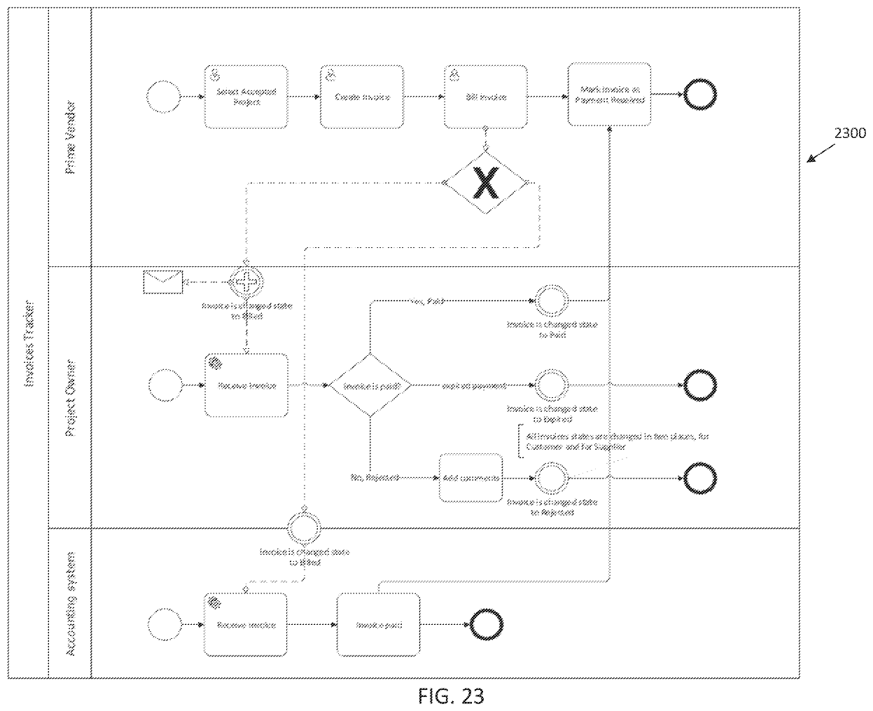

FIG. 23 is a flowchart illustrating an exemplary process 2300 for interaction between users, Project Owner and Prime Vendor within the invoice tracker subsystem 130 of an embodiment of the collaborative, multi-user platform 100. A prime vendor can selected an accepted project, create an invoice for the selected project, and implement a bill function for the invoice. In response to transmitting the invoice to the project owner, the invoice tracker of the platform can change the state of the invoice to “billed”. Upon receipt of the invoice by the project owner, a determination is made as to whether or not to pay the invoice. If the invoice is paid, the state of the invoice in the invoice tracker is changed to “paid” and the invoice is marked payment received. If the deadline for billing has expired, the state of the invoice in the invoice tracker is changed to “expired”. If the invoice is rejected, the state of the invoice in the invoice tracker is changed to “rejected”.

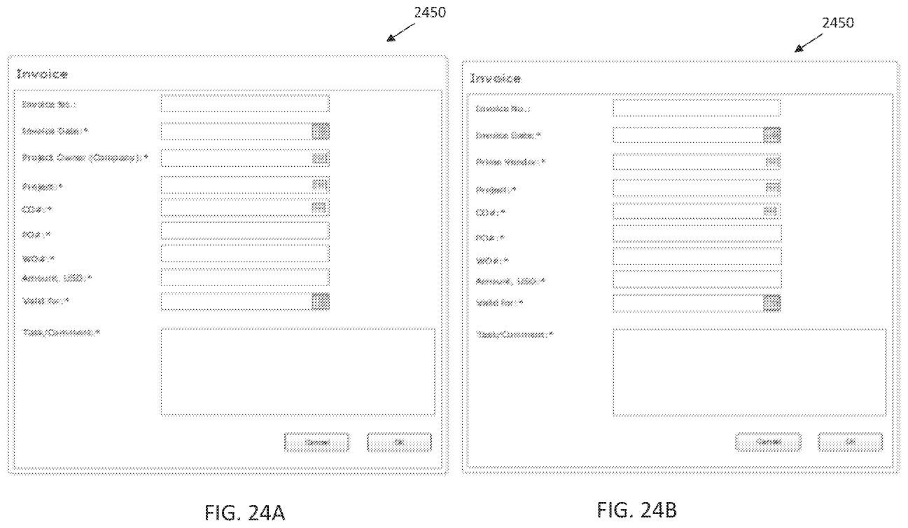

FIG. 24A-B are GUIs 2400 and 2450 of a main interface of the invoice tracker subsystem 130 in accordance with embodiments of the present disclosure. The GUIs 2400 and 2450 can include data entry fields for invoice numbers, invoice dates, prime vendor or project owner, a CO number, a PO number, a WO number, an amount, an expiration date, and/or a task or comment.

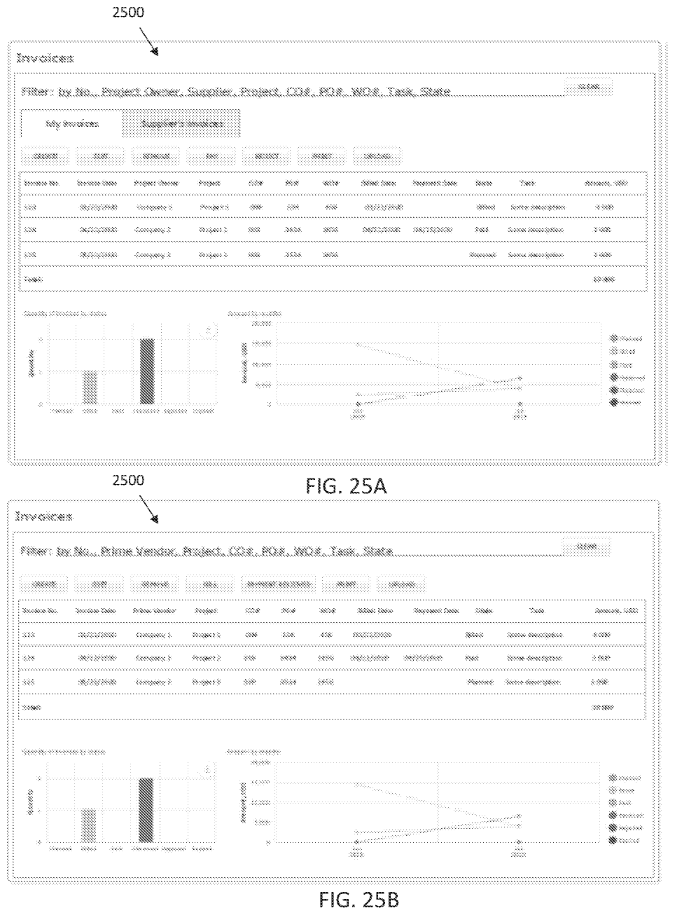

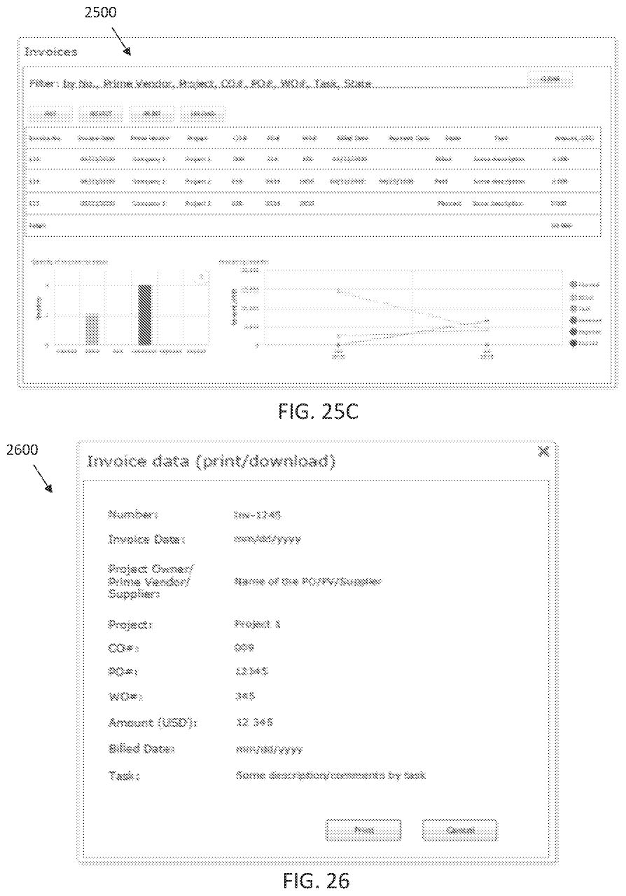

FIG. 25A-C are GUIs 2500 for invoice forms for a prime vendor, a supplier, and a project owner that are rendered by the invoice tracker subsystem 130 in accordance with embodiments of the present disclosure. The GUIs 2500 can list invoices that have been issued in the invoice tracker subsystem including the information entered in the GUIs 2400 and/or 2450 from FIGS. 24A-B. The GUIs can also include graphics and/or charts to illustrate invoice information.

FIG. 26 is a GUI 2600 of a print/upload window of the invoice tracker subsystem 130 in accordance with embodiments of the present disclosure. The GUI 2600 can provide invoice information that can be printed user saved by the user. The invoice information can include information entered in the GUIs 2400 and/or 2450 from FIGS. 24A-B.

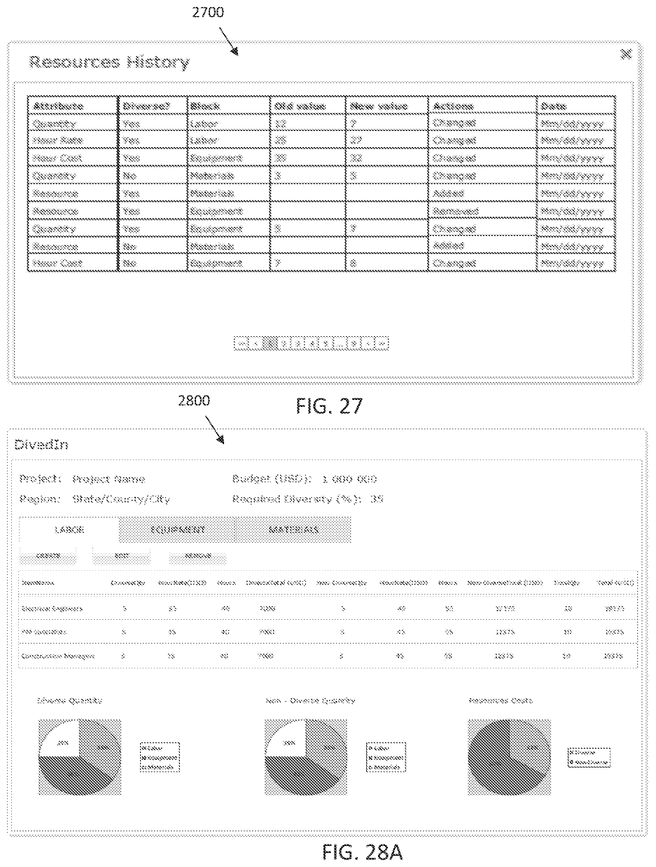

FIG. 27 is a GUI 2700 providing a revision history provided as list by the Diversity Planning and Team Optimizer subsystem 120 in accordance with embodiments of the present disclosure. This GUI 2700 is displayed by clicking on the “History” button on the functionality panel of the Diversity Planning and Team Optimizer subsystem 120 (see FIG. 28). The GUI 2700 can list a history of resources for a registered company to allow users to view the history of a company in the platform and to determine changes to the company over time.

FIG. 28A-B are GUIs 2800 2850 of forms for the project owner and the supplier in the Diversity Planning and Team Optimizer subsystem 120 in accordance with embodiments of the present disclosure. The GUI 2800 can be generated by the subsystem 120 for the project owner and the GUI 2850 can be generated by the subsystem 120 for the supplier. The GUIs 2800 and 2850 can provide tabs for viewing information about resources and can include a labor tab, an equipment tab, and a materials tab. The GUIs 2800 and 2850 can list information about the resources including item names, diverse/non-diverse status and quantities and costs, and can provide graphics and/or charts for illustrating the information. The GUIs 2800 and 2850 can include options for creating, editing, and/or removing an item from the list of items for the resources. The GUI 2850 can also include options for optimizing a team based on diversity and options to view or access project requests, pre-bid reports, contracts, and/or a history. The GUI 2850 can also include a start option and a finish option. The start option allows the supplier to officially start the project and run a report to determine the planned value for various resources tracked by the diversity planner and team optimizer subsystem. The finish option allows the supplier to officially finish (close-out) the project and run a report to determine the actual value of various resources used during the project, which are tracked by the diversity planner and team optimizer subsystem. These options allow users to run a variance report to understand the trend in the change of supplier diversity level throughout the project lifecycle.

FIG. 29A-B are GUIs 2900 and 2950 for rendering resources within the form for the supplier in the Diversity Planning and Team Optimizer subsystem 120 in accordance with embodiments of the present disclosure. This form is displayed by clicking on the Diverse Quantity/Non-Diverse Quantity item in the list of the resources in FIG. 28A or 28B. The GUIs 2900 and 2950 can list the individual resources that correspond to the quantity and can identify the RN (“Resource Name”) code, the supplier name, certificates, a quantity of the resource from each supplier listed, and/or a gender.

FIG. 30 is a GUI 3000 for rendering a selected labor list in the Diversity Planning and Team Optimizer subsystem 120 in accordance with embodiments of the present disclosure. This form is displayed by clicking the “Create” button in FIG. 28A or 28B (under the “Labor” tab). The GUI 3000 can allow a user to add, remove, and/or duplicate information for inclusion in the resource lists (e.g., in GUIs 2800 and 2850). In the present example, for labor resources, the user can specify an occupation, a diverse quantities, and costs. The GUI 3000 also includes an “add from library” option that can be selected. The library can include predefined resource information to provide uniformity and consistent to the names or types of the resources in embodiments of the platform 100. For example, the library for labor resources can include names of occupations that can be selected by the user when generating labor resource information.

FIG. 31 is a GUI 3100 for rendering a library of selectable labor options in the Diversity Planning and Team Optimizer subsystem 120 in accordance with embodiments of the present disclosure. This form is displayed by clicking the “Add from library” button in FIG. 30. The library can include predefined resource information categorized using one or more occupation codes. A user can search for occupations by entering a search string that can include a user-specified occupation or code, and the platform can search the database(s) for a matching or semantically close occupations and return a list of occupations. The users define diversity statuses for each labor classification or occupation code in the platform as described herein. Users can search the library database(s) for a match and return list of occupations. Also, the user can search for diverse and non-diverse labor resources that matches the list of occupations generated by the platform system by querying the SMB portal database(s) with registered suppliers' labor resources info with the diverse or non-diverse option selected, and through external third-party database/application such as LinkedIn that are integrated to the platform.

FIG. 32 is a GUI 3200 for rendering a selected equipment list in the Diversity Planning and Team Optimizer subsystem 120 in accordance with embodiments of the present disclosure. This form is displayed by clicking the “Create” button in FIG. 28A or 28B (under the “Equipment” tab). For equipment resources, the user can specify an item names, quantities, diversity, and cost information. The GUI 3200 also includes an “add from library” option that can be selected. The library can include predefined resource information to provide uniformity and consistent to the names or types of the resources in embodiments of the platform 100.

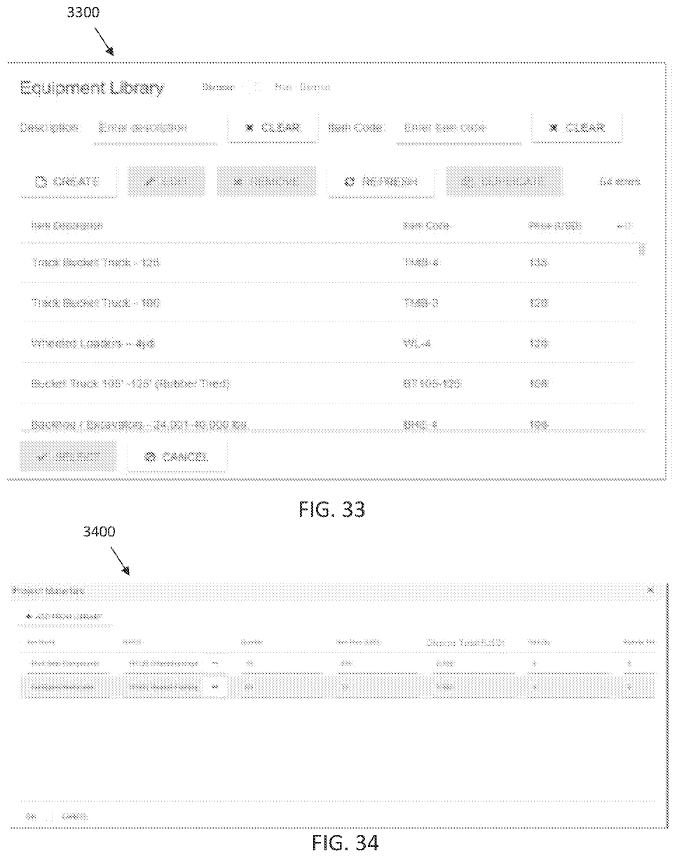

FIG. 33 is a GUI 3300 for rendering a library of selectable equipment options in the Diversity Planning and Team Optimizer subsystem 120 in accordance with embodiments of the present disclosure. This form is displayed by clicking the “Add from library” button in FIG. 32. The library can include predefined resource information categorized using one or more equipment codes. A user can search for equipment by entering a search string that can include a user-specified equipment name or code, and the platform can search the database(s) for a matching or semantically close equipment and return a list of equipment. The library can allow a user to create, edit, remove, and/or duplicate entries in the library to add, edit, or delete equipment from the library. The user can click on the equipment listed in the library to add it to their list of inventory. As described herein, the diversity status of the registered supplier in the SMB portal database can be specified and a diverse/non-diverse option can be selectable such that when the equipment library is queried, equipment matching the query are returned that are provided by the diverse or non-diverse supplier to generate an equipment list.

FIG. 34 is a GUI 3400 for rendering a selected material list in the Diversity Planning and Team Optimizer subsystem 120 in accordance with embodiments of the present disclosure. This form is displayed by clicking the “Create” button in the FIG. 28A or 28B (“Materials” tab). For material resources, the user can specify an item names, quantities, diversity, and cost information. The GUI 3200 also includes an “add from library” option that can be selected. The library can include predefined resource information to provide uniformity and consistent to the names or types of the resources in embodiments of the platform 100.

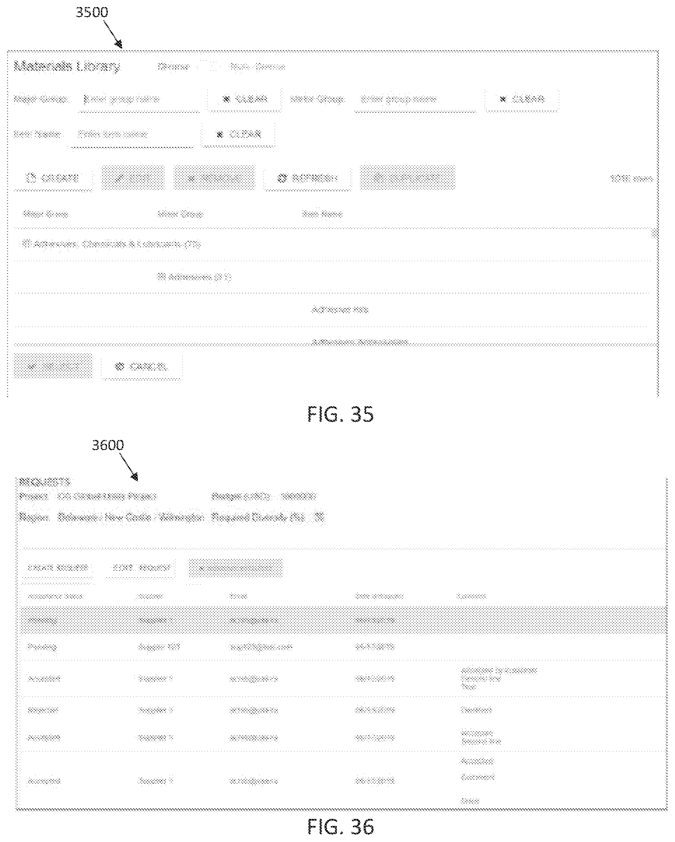

FIG. 35 is a GUI 3500 for rendering a library of selectable materials options in the Diversity Planning and Team Optimizer subsystem 120 in accordance with embodiments of the present disclosure. This form is displayed by clicking the “Add from library” button in FIG. 34. The library can include predefined resource information categorized using one or more categories. A user can search for materials by entering a search string that can include a user-specified major group name, minor group name, and/or item name, and the platform can search the database(s) for a matching or semantically close material and return a list of material. The library can allow a user to create, edit, remove, and/or duplicate entries in the library to add, edit, or delete material from the library. The user can click on the material listed in the library to add it to their list of inventory. As described herein, the diversity status of the registered supplier in the SMB portal database can be specified and a diverse/non-diverse option can be selectable such that when the materials library is queried, materials matching the query are returned that are provided by the diverse or non-diverse supplier to generate a materials list.

FIG. 36 is a GUI 3600 for rendering a request list form for a prime vendor in the Diversity Planning and Team Optimizer subsystem 120 in accordance with embodiments of the present disclosure. The GUI 3600 can identify a project name, region, budget, and diversity requirement, and can identify requests submitted to suppliers and a status of the requests. The GUI 3600 also allows the user to create, edit, or remove requests.

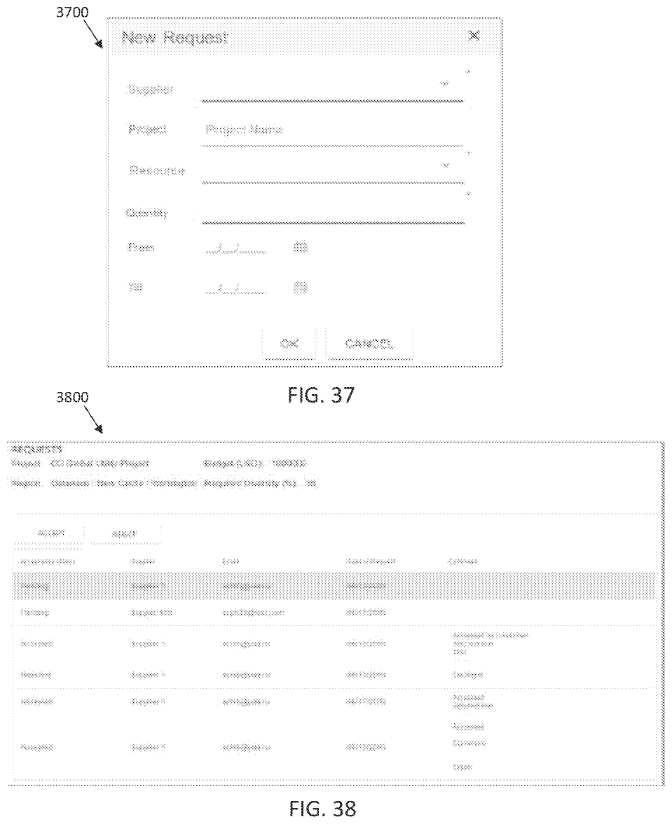

FIG. 37 is a GUI 3700 for rendering a new request form for a prime vendor in the Diversity Planning and Team Optimizer subsystem 120 in accordance with embodiments of the present disclosure. The GUI 3700 can include data entry fields for receiving information for a new request include a supplier name, a project name, a resource, a quantity of the resource, and time period.

FIG. 38 is a GUI 3800 for rendering a request list form for a supplier in the Diversity Planning and Team Optimizer subsystem 120 in accordance with embodiments of the present disclosure. The GUIs can list requests for consideration that include the supplier name, the status of the request and other information. The user can select the accept option to accept a request and a reject option to reject the request.

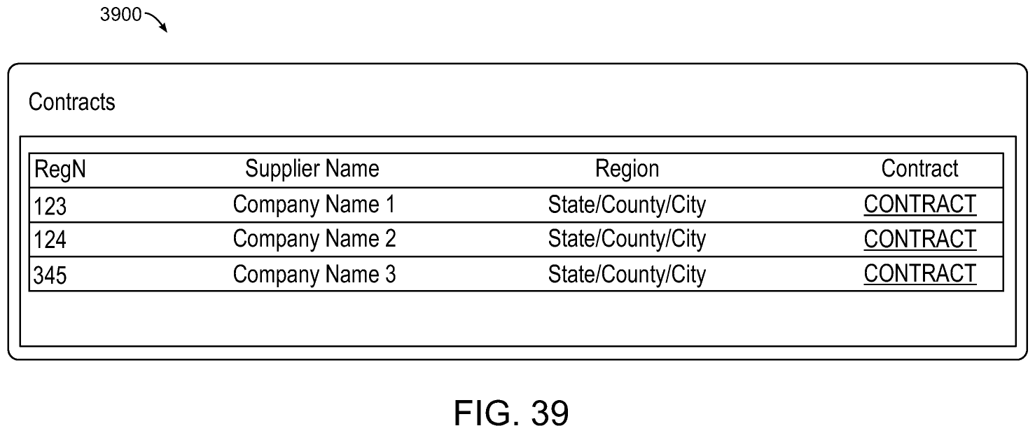

FIG. 39 is a GUI 3900 for rendering a contracts list form for a prime vendor in the Diversity Planning and Team Optimizer subsystem 120 in accordance with embodiments of the present disclosure.

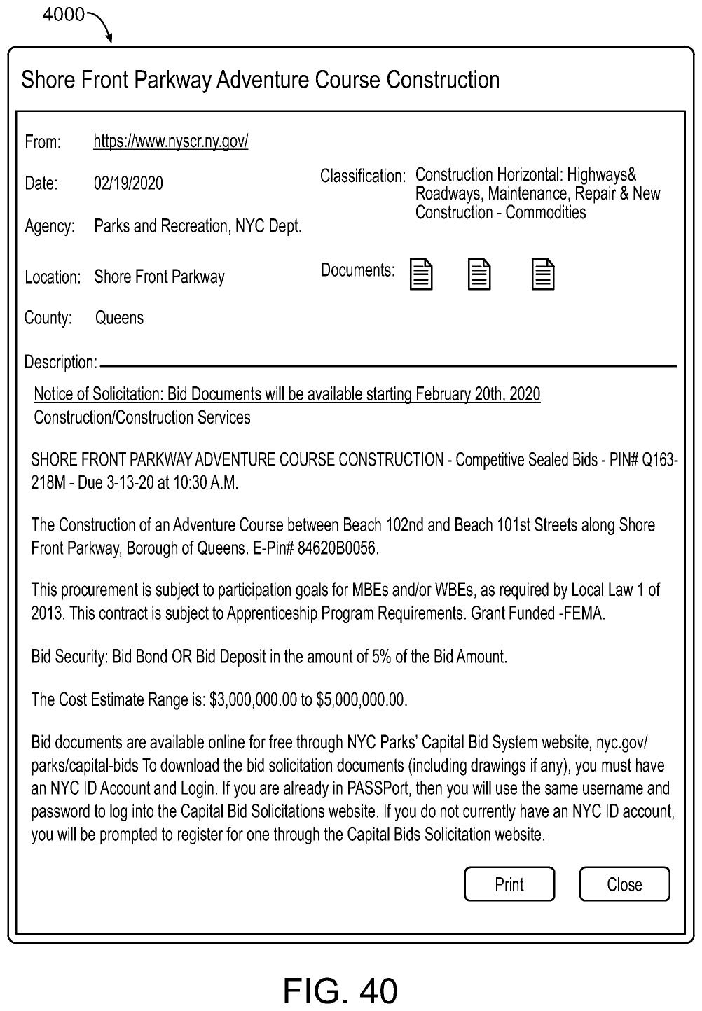

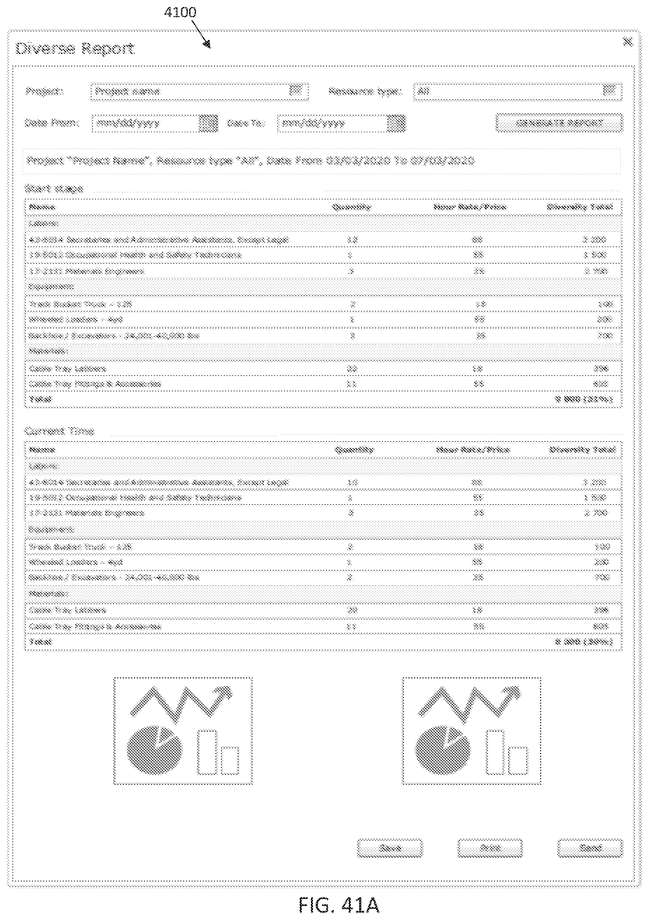

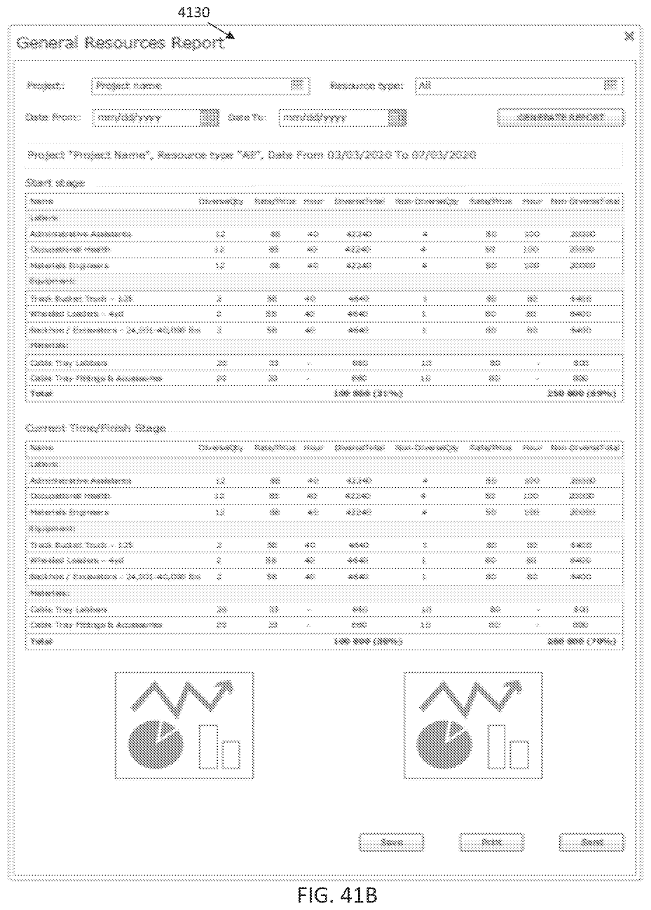

FIG. 40 depicts an exemplary GUI 4000 for an embodiment of the SMB portal 110 in accordance with embodiments of the present disclosure. The GUI 4000 shows information of a project that is available for bids.

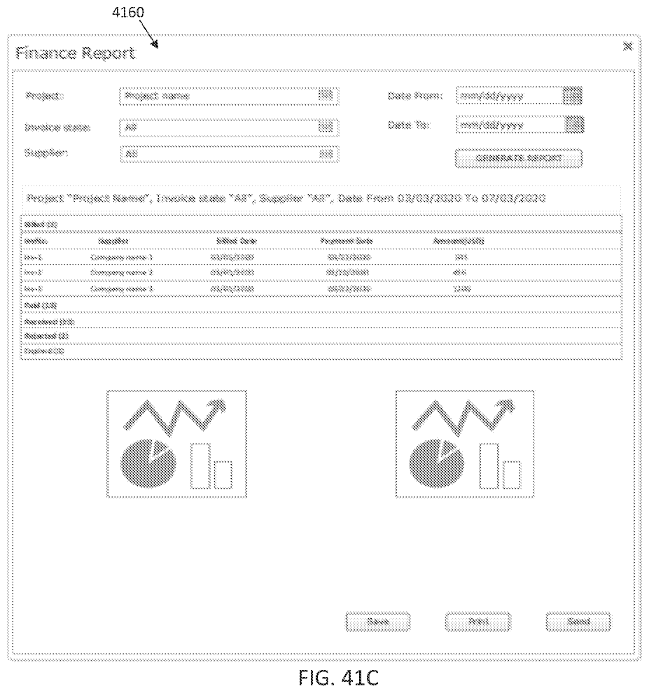

FIGS. 41A-C are GUIs 4100, 4130, and 4160 providing reports including, for example, a diversity report (FIG. 41A), a general resource report (FIG. 41B), and a finance report (FIG. 41C). The reports can provide information associated with one or more projects where the information can be filtered based on a time period and/or resource types. The reports can be include information corresponding to resources at the start of a project, a current time of the project, and/or at the completion of the project.

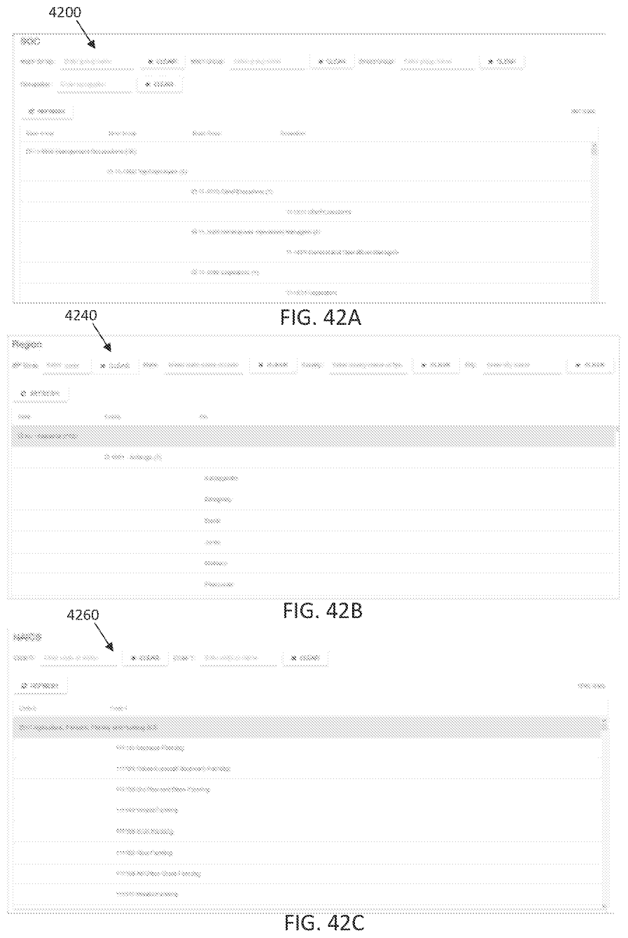

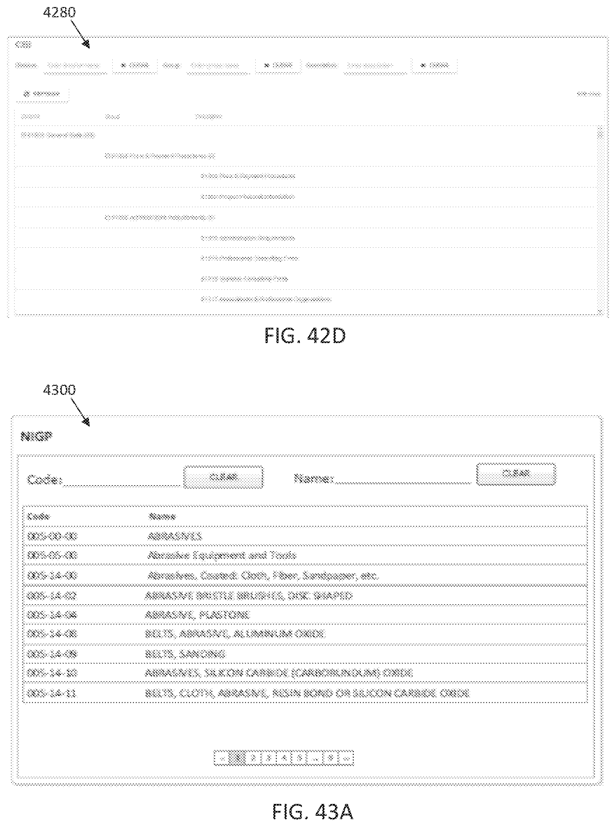

FIGS. 42A-D are GUIs 4200, 4240, 4260, and 4280 providing libraries including, for example, a Standard Occupational Classification (SOC) library (FIG. 42A), a regions library (FIG. 42B), an NAICS library (FIG. 42C), and a Construction Specification Institute (CSI) library (FIG. 42D). The SOC library can allow users to search the occupation library by major group, minor group, broad group, and/or occupation, and can list the results of a query of the occupation library in the database(s). The regions library can allow a user to search the regions library by zip code, state, country, and/or city name, and can list the results of a query of the regions library in the database(s). The NAICS library can allow users to search NAICS library based on classification codes, and can list the results of a query of the NAICS library in the database(s). The CSI library can allow users to search CSI library based on a division name, group, and/or description, and can list the results of a query of the CSI library in the database(s).

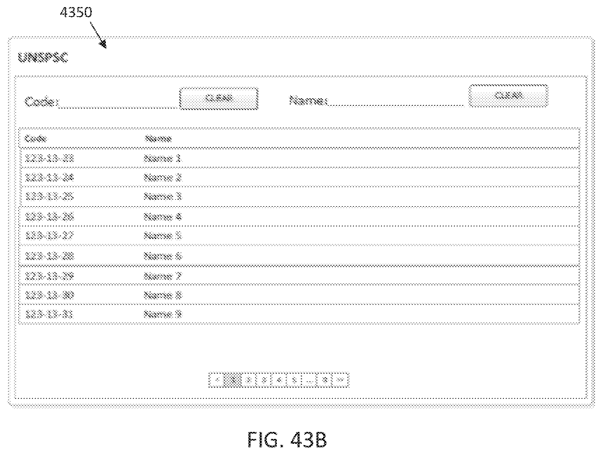

FIGS. 43A-B are GUIs 4300 and 4350 providing libraries including, for example, a National Institute of Governmental Purchasing Commodity Codes (NIGP) library (FIG. 43A) and a United Nations Standard Products and Services Code (UNSPSC) library (FIG. 43B). The NIGP library can allow a user to search by code and/or a name, and can list of materials categories results from a query of the NGIP library in the database(s). The UNSPSC library can allow a user to search by code and/or a name, and can list of results from a query of the UNSPSC library in the database(s).

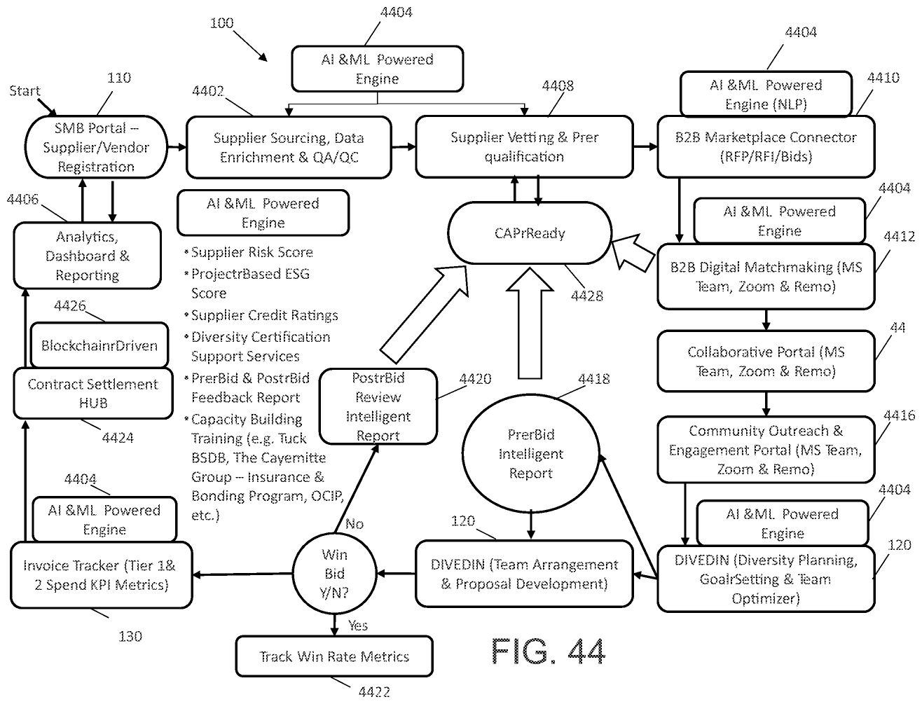

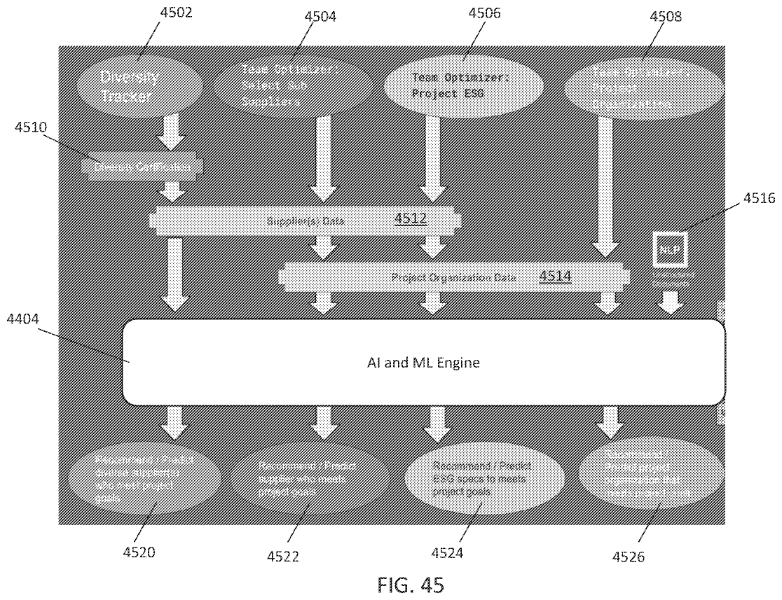

FIG. 44 illustrates an overview of an implementation of an embodiment of the platform 100 in accordance with embodiments of the present disclosure. A user can interact with the SMB port 110 via one or more graphical user interfaces to input data for consumption by the platform 100 after which one or more of supplier sourcing, data enrichment, and quality control processes 4402 are implemented by the platform 100 in conjunction with an ensemble of trained and tiered machine learning (ML) and artificial intelligence (AI) models provided by an AI and ML engine 4404 of the AI data analytics and reporting subsystem 150. The AI and ML engine 4404 of the AI data analytics and reporting subsystem 150 can model what supplier and owner factors contribute to positive or negative (good or bad) project outcomes. A suite of models can be utilized by the AI and ML engine 4404 depending on the model-explainability needs, data use, and model explanation preferences of users. When used in conjunction with one or more of supplier sourcing, data enrichment, and quality control processes 4402, an instance of the AI and ML engine 4404 can receive data about projects, suppliers, project owners, as well as other data as its inputs and can output predictions or recommendations to improve the likelihood of a successful outcome. The user can also access dashboard 4406 provided as a graphical user interface by the AI data analytics and reporting subsystem 150.

An output of the one or more of supplier sourcing, data enrichment, and quality control processes 4402 can be provided as an input to a supplier vetting and pre-qualification process 4408 implemented by the platform 100 in conjunction with the ensemble of trained and tiered machine learning (ML) and artificial intelligence (AI) models provided by the AI and ML engine 4404 of the AI data analytics and reporting subsystem 150. When used in conjunction with the supplier vetting and pre-qualification process 4408, an instance of the AI and ML engine 4404 can receive supplier safety data or insurance data as its inputs and can output supplier risk scores.

An output of the supplier vetting and pre-qualification process 4408 can be provided as an input to a business-to-business market connector 4410 of the connection and Integration gateways subsystem 140 implemented by the platform 100 in conjunction with the ensemble of trained and tiered machine learning (ML) and artificial intelligence (AI) models provided by the AI and ML engine 4404 of the AI data analytics and reporting subsystem 150. When used in conjunction with the supplier vetting and pre-qualification process 4408, an instance of the AI and ML engine 4404 can receive supplier risk scores and diversity certification data as its inputs and can output collaborative teaming partners.

Selections and inputs received from the user via the business-to-business market connector 4410 can feed a business-to-business digital matchmaking module 4012 of the platform 100 that allows the user to match the best-fit opportunities for business growth. The business-to-business digital matchmaking module 4412 of the platform 100 can feed a collaborative portal 4414 of the platform 100 that allow the users of the platform to collaborate with each other as described herein, and the collaborative portal can feed a community outreach and engagement portal 4416 of the platform 100 allows the users to gather insights about community stakeholder's needs and how to best meet or exceed these needs.

The DivedIn subsystem 120 can be implemented in conjunction with the ensemble of trained and tiered machine learning (ML) and artificial intelligence (AI) models provided by the AI and ML engine 4404 of the AI data analytics and reporting subsystem 150 to define one or more members of a team and/or complete one or more bids on one or more projects based on a pre-bid intelligent report 4418 that includes supplier diversity goal (%) and/or one or more outputs of the AI and ML engine 4404. When used in conjunction with the DivedIn subsystem 120, an instance of the AI and ML engine 4404 can receive supplier data and diversity certification data as its inputs and can output diverse supplier utilization rates and supplier risk scores.

A cap ready module of the platform 100 receive as inputs an output of the supplier vetting and pre-qualification process 4408, an output of the business-to-business digital matchmaking module 4412, the pre-bid report 4418, and the post-bid report 4420. The cap read module 4428 can use the inputs as feedback to generate a supplier verification & validation, capacity building and business improvement recommendation solution that provides guidance to the user.

As shown in FIGS. 44 and 45, several services and/or subsystems of the platform with which the users can interact through platform use identical AI and ML models by asking the same “overall” project outcome performance by, in a sense, varying a different slice of the input to the AI and ML engine 4404. Whether ESG or supplier details or RFP inputs to the AI and ML engine 4404 are being varied, the overall model can predict how the success of a given project as a whole may be affected based on the inputs. The AI and ML engine 4404 determine, detect, and/or identify impacts on projects using trained models. For example, when a project owner is looking for a diverse supplier you, the project owner is not only looking for anyone who has the requisite diverse certification, but is also looking at separate needs that must be satisfied. In this respect, a project owner may need a supplier who is diverse certified and will also contribute and perform well within the parameters of a project. Either of those alone is not enough. The AI and ML engine 4404 goes beyond simply identifying suppliers that have the requisite diverse certification by predicting impacts on the whole project using trained artificial intelligence and machine learning algorithms. The AI and ML engine 4404 can organize supply chain procurement and manage diversity within the supply chain procurement process.

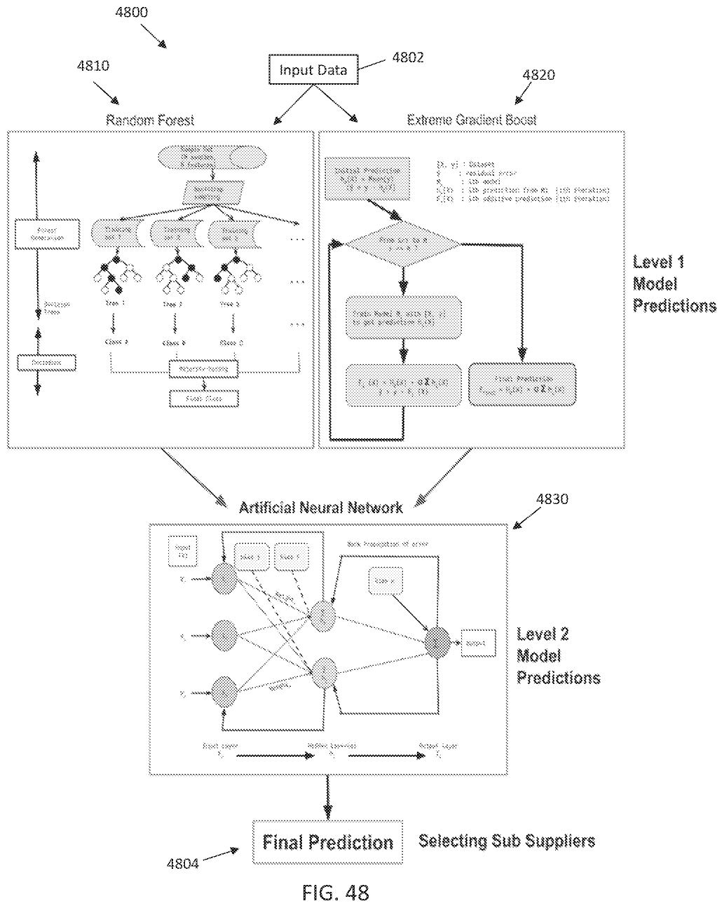

Different users can have divergent needs and platform 100 can meet these different needs with a suite of AI and ML models, as described herein, including, for example, limited simple explainable general linear models machine-learning/statistical-learning; flexible decision tree machine learning (feature explanation and nonlinear); full delux neural network AI machine learning. The ensemble of trained AI and ML models can select from models that are more resilient to either false positive or false negative errors and/or can selecting specific (rather than general and combined) project performance measures (e.g., see FIG. 48). For example, if for a particular project ‘safety’ was an extremely serious concern, the platform 100, via the AI and ML engine 4404 generate a specific prediction of how a given set of sub-suppliers and project organization may perform in that specific ‘safety’ context (and the same for any other sub-context for project outcomes).

The services 4502-4508 can be called by the platform 100, or the subsystems thereof and executed to submit data 4510-4516 as an input to the AI and ML engine 4404. The services can include diversity tracker services 4502, team optimizer for selection of sub-suppliers 4504, team optimizer for environmental, social, and governance (ESG) projects 4506, and team optimizer for project organization 4608. The data can include diversity certification data 4510, supplier data 4512, project organization data 4514, and data 4516 from unstructured documents extracted using natural language processing (NLP). The trained models of the AI and ML engine 4404 can receive this data and generate one or more outputs (e.g., predictions/recommendations). As an example, in response to the data 4510 and 4512 received for the diversity tracker 4502, the AI an ML engine 4404 can output a recommendation or prediction 4520 corresponding to which diverse suppliers in the platform 100 may satisfy one or more goals associate with a specified project. As another example, in response to the data 4512 and 4514 received for the team optimizer for selection of sub-suppliers 4504, the AI an ML engine 4404 can output a recommendation or prediction 4522 corresponding to which suppliers may satisfy one or more goals associate with a specified project. As another example, in response to the data 4512 and 4514 received for the team optimizer for environmental, social, and governance (ESG) projects 4506, the AI an ML engine 4404 can output a recommendation or prediction 4524 corresponding to ESG parameters that may satisfy one or more goals associate with a specified project. As another example, in response to the data 4512 and 4514 received for the team optimizer for project organization 4608, the AI an ML engine 4404 can output a recommendation or prediction 4526 corresponding to which organizations may satisfy one or more goals associate with a specified project.

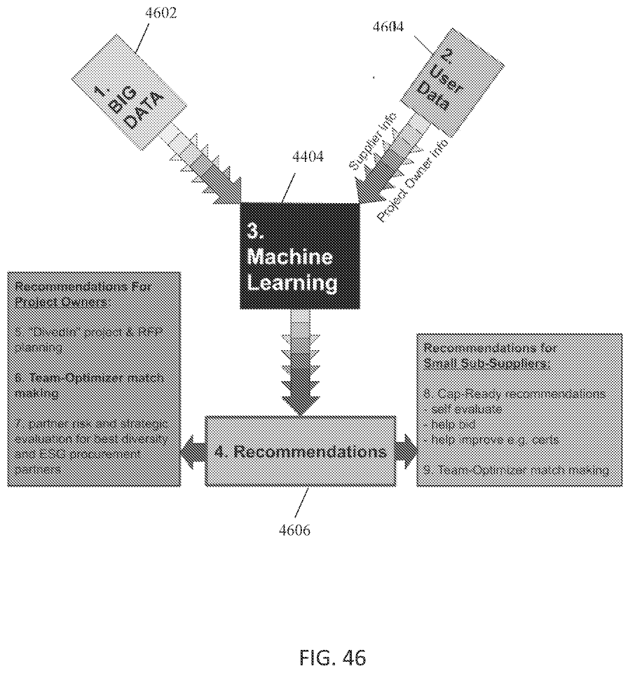

FIG. 46 illustrates a general overview of an embodiment of the AI and ML engine 4404 in accordance with embodiments of the present disclosure. As described herein, the platform 100 can use machine learning and artificial intelligence to make predictions and recommendations supporting supply chain management and accommodating diversity-inclusion and environment, social and governance (ESG). For example, the platform can use machine learning and artificial intelligence to generate recommendations for project owners and recommendations for subcontractor/diverse suppliers. The AI and ML engine 4404 of the platform 100 can receive big data 4602 and user data 4604 as inputs. Some example sources of the data included in the big data set can include data from SAM.gov, OSHA, EPA, etc.; data from company partners such as S&P Global; partner procurement data about projects and suppliers; and data from projects in the platform 100. Some examples of user data 4604 input to the platform 100 can include data from small subcontractor/diverse supplier who want to bid for an RFP or join a prime vendor; data about a project and request for proposals (RFPs) from project owners. The AI and ML engine 4404 can execute a ensemble of trained AI and ML models in a tiered or hierarchical structure to generate recommendations and/or predictions 4606 based on the big data 4602 and the user data 4604. As an example, the AI and ML engine 4404 can use statistical, neural network, and other models trained on the big data 4602. The AI and ML engine 4404 can use parametric general linear models (GLMs), statistical linear regression and logistic regression, decision tree models such as XG-Boost, and/or artificial neural networks that can operate using unstructured and/or structured data.

As an example of predictions and recommendations 4606 that can be output by the AI and ML engine 4404 based on the big data 4602 and 4604 for project owners can include, for example, project and RFP planning via the DivedIn subsystem 120; recommended project design and management suggestions (e.g. carbon targets, diversity targets, etc.); predicted ESG scores; predicted risks associated with projects; recommended best-match partners for team-optimization match making via the DivedIn subsystem 120; and/or partner risk and strategic evaluation for best diversity and ESG procurement partners.

As an example of predictions and recommendations 4606 that can be output by the AI and ML engine 4404 based on the big data 4602 and 4604 for suppliers can include, for example Cap-Ready recommendations; self-evaluation; help generating bids for projects on the platform 100; recommendations to improve a likelihood of winning bids; recommendations for self-improvement; and/or recommended best-match partners for team-Optimization match making for suppliers.

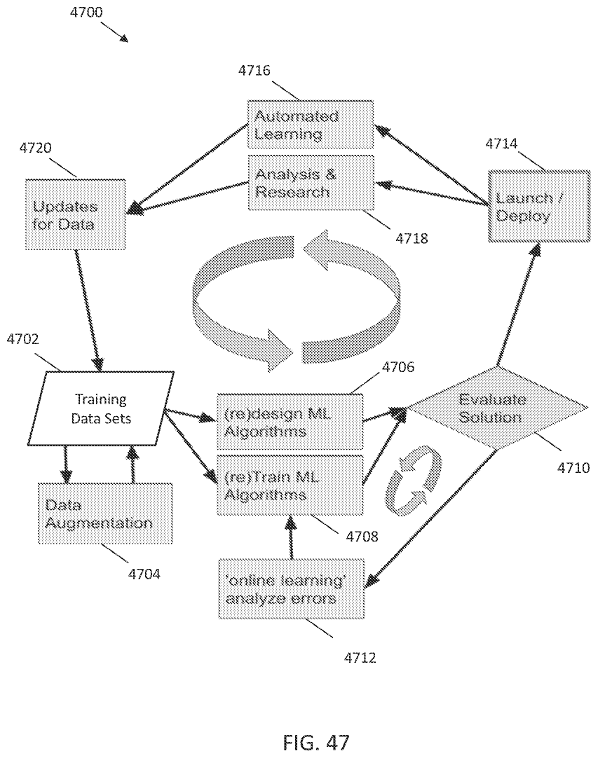

FIG. 47 illustrates an example process for training artificial intelligence and machine learning models of the platform 100 in accordance with embodiments of the present disclosure. As shown in FIG. 47, training data 4702 is generated to train the AI and ML models. The training data 4702 can include big data 4602 and user data 4604 (FIG. 46). As an example, for big data, the platform can collect data about suppliers, such as a name, geographic location/footprint, number employees, supplier Osha records, supplier EPA records, supplier NAICS codes, supplier certifications (e.g., diversity certification), reference surveys about suppliers, supplier company policies, supplier credit ratings, supplier bonding information, and the like. As an example, for user data, the platform 100 can collect data about projects, project outcomes, outcomes associated components of projects (e.g., budget data, schedule/timeliness, diversity goals, positive surveys, environment goals, social goals, safety, satisfaction of objectives), project owners, suppliers, and the like, and can be incorporate this data into the training data. As a non-limiting example, training data associated with tens of thousands of projects and outcomes associated with project components can be integrated into the training data set.

Prior to training the AI and ML models using the training data 4702, the training data is augmented 4704, e.g., to tokenize, normalize, lemmatized, transformed into canonical form, and the like. After the training data 4702 is augmented, the AI and ML algorithms of the AI and ML engine 4404 are designed 4706 and trained 4708 using the training data. As described herein, an ensemble of AI and ML algorithms are trained and deployed in the platform 100 and can be structured to be implemented in a tiered hierarchical structure. After the AI and ML models have been trained, the models are tested or validated to evaluate 4710 the trained AI and ML models, and a feedback loop is formed to analyze errors 4712 in the outputs of the trained AI and ML models and adjust or optimize the trained models 4708. After the trained AI and ML models have been validated 4710, the trained AI and ML models can be launched/deployed 4714 in the platform 100, and the platform 100 can call and execute the deployed, trained AI and ML models as an ensemble in the tiered hierarchical structure to facilitate automated learning 4716 and analysis 4718. The inputs and outputs of the deployed and trained AI and ML models can be used to update 4720 the data in the training data sets 4702, which can be augmented 4704, and used to re-design 4706, retrain 4708, and re-validate 4710 the AI and ML models before deploying 4714 updated trained AI and ML models in platform 100 in place of the previous version of the trained AI and ML models.

FIG. 48 illustrates a tiered, hierarchical artificial intelligence and machine learning ensemble 4800 of an embodiment of the AI and ML engine 4404 in accordance with embodiments of the present disclosure. The ensemble 4800 can receive input data 4802 including, e.g., big data 4602 and user data 4604 and can output one or more predictions or recommendations 4804. The input data can include data about suppliers and projects. The input data 4802 can change over time as new data is generated or collected by the platform and as insights (gleaned from models and analysis) identify features that can influence or enhance the accuracy of the predictions generated by the AI and ML engine 404. The ensemble 4800 can include a first tier or level that includes two or more artificial intelligence and machine learning models and a second level or tier that includes at least one artificial intelligence and machine learning model. The artificial intelligence and machine learning models of the first tier can receive the receive input data 4802 and can be executed in parallel based on the input data. Each of the models in the first tier can generate an output based on execution of the models in conjunction with the input data 4802. The outputs of the models in the first tier can form inputs of the at least one model in the second tier. Using the outputs from the models in the first tier, the at least one model in the second tier can generate the final prediction or recommendation 4804.

The first tier of the ensemble can include, for example, a random forest model 4810 and a trained extreme gradient boost model 4820. The trained random forest model 4810 can generate a set of decision trees based on the input data 4802 and can generate a set of predictions or classifications based on the decision trees. The prediction or classification that is output by the trained random forest model 4810 can be determined using a voting scheme (e.g., such as a majority voting scheme where the prediction or classification that occurs most frequently based on the decision trees can be selected). The data utilized by the random forest model 4810 can be structure data. The trained extreme gradient boost model 4820 can use regression analysis that generates a series of decision trees where a next decision tree is generated from errors or residuals form a previous decision tree to generate a second decision tree. The data utilized by the extreme gradient boost model can be structured data (e.g., in tabular form). The second tier can include a neural network 4830 (e.g., a deep or convolutional neural network). The data utilized by the trained neural network 4830 can use unstructured and/or structured data and can include the outputs of the models in the first tier.

The final predication 4804 can be based on one or more components or intermediate predictions or recommendation generated by the models in the first and second tiers. The components or intermediate predictions/recommendations can be defined for a project in the platform 100 based on parameters of the project or other data. As a non-limiting example, the components or intermediate predictions/recommendations can include budget data, schedule/timeliness, diversity goals, positive surveys, environment goals, social goals, safety, satisfaction of objectives. The components or intermediate predictions/recommendations can be assigned a values depending on whether they are positive or negative and the final prediction can be sum of the values assigned to the components or intermediate predictions/recommendations. As an example, the budget component can be assigned a “+1” if the predicted outcome is that the project will be within budget or can be assigned a “−1” if the predicted outcome is that the project will be over budget. An advantage of this structure for the final prediction is that the final prediction can be modeled as line-fitting regression or a classification problem. This allows the ensemble 4800 to be flexibly used for examination and prediction using a wider variety of models.

Exemplary flowcharts are provided herein for illustrative purposes and are non-limiting examples of methods. One of ordinary skill in the art will recognize that exemplary methods may include more or fewer steps than those illustrated in the exemplary flowcharts, and that the steps in the exemplary flowcharts may be performed in a different order than the order shown in the illustrative flowcharts.

The foregoing description of the specific embodiments of the subject matter disclosed herein has been presented for purposes of illustration and description and is not intended to limit the scope of the subject matter set forth herein. It is fully contemplated that other various embodiments, modifications and applications will become apparent to those of ordinary skill in the art from the foregoing description and accompanying drawings. Thus, such other embodiments, modifications, and applications are intended to fall within the scope of the following appended claims. Further, those of ordinary skill in the art will appreciate that the embodiments, modifications, and applications that have been described herein are in the context of particular environment, and the subject matter set forth herein is not limited thereto, but can be beneficially applied in any number of other manners, environments and purposes. Accordingly, the claims set forth below should be construed in view of the full breadth and spirit of the novel features and techniques as disclosed herein.

1. A collaborative, multi-user system, comprising:
one or more computer-readable media storing a platform and data associated with one or more users and one or more projects; and
a processing device configured to execute the platform to:
generate one or more graphical user interfaces through which the users interact with the platform to facilitate supplier diversity planning and supply chain localization delivery for one or more phases of the one or more projects;
create proposal or bid documents by automatically or semi-automatically generating data for pre-bid intelligent reports; and
track a status of the one or more projects and supplier diversity and local content associated with the one or more projects.

2. The system of claim 1, wherein the processing device is configured to execute the platform to:
train an ensemble of machine learning models based on training data that includes at least supplier data and project data, the ensemble of machine learning models having a tiered hierarchical configuration; and
execute the trained ensemble of machine learning models to automatically or semi-automatically generate data for pre-bid intelligent reports, proposals or bid documents.

3. The system of claim 2, wherein the trained ensemble of machine learning models includes a first tier formed by at least two different machine learning models and a second tier formed by at least one other machine learning model that is different than the at least two machine learning models in the first tier.

4. The system of claim 3, wherein the at least two machine learning models of the first tier include a random forest model and an extreme gradient boost model.

5. The system of claim 3, wherein the at least one machine learning model of the second tier is a neural network model.

6. The system of claim 3, wherein the at least two machine learning models in the first tier are configured to be executed in parallel.

7. The system of claim 3, wherein the at least one machine learning model in the second tier receives outputs from the at least two machine learning models in the first tier and generates a final output based on the outputs from the at least two machine learning models.

8. A method for a collaborative, multi-user system, comprising:
generating one or more graphical user interfaces through which users interact with a platform to facilitate supplier diversity planning and delivery for one or more phases of one or more projects;
creating proposal or bid documents by automatically or semi-automatically generating data for pre-bid intelligent reports; and
tracking a status of the one or more projects and supplier diversity and local content associated with the one or more projects.

9. The method of claim 8, further comprising:
training an ensemble of machine learning models based on training data that includes at least supplier data and project data, the ensemble of machine learning models having a tiered hierarchical configuration; and
execute the trained ensemble of machine learning models to automatically or semi-automatically generate data for pre-bid intelligent reports, proposals or bid documents.

10. The method of claim 9, wherein the trained ensemble of machine learning models includes a first tier formed by at least two different machine learning models and a second tier formed by at least one other machine learning model that is different than the at least two machine learning models in the first tier.

11. The method of claim 10, wherein the at least two machine learning models of the first tier include a random forest model and an extreme gradient boost model.

12. The method of claim 10, wherein the at least one machine learning model of the second tier is a neural network model.

13. The method of claim 10, wherein the at least two machine learning models in the first tier are configured to be executed in parallel.

14. The method of claim 10, wherein the at least one machine learning model in the second tier receives outputs from the at least two machine learning models in the first tier and generates a final output based on the outputs from the at least two machine learning models.

15. A non-transitory computer-readable medium storing instructions, wherein execution of the instructions by a processing device causes the processing device to:
generate one or more graphical user interfaces through which users interact with a platform to facilitate supplier diversity planning and supply chain localization delivery for one or more phases of one or more projects;
create proposal or bid documents by automatically or semi-automatically generating data for pre-bid intelligent reports; and
track a status of the one or more projects and supplier diversity and local content associated with the one or more projects.

16. The non-transitory computer-readable medium of claim 15, wherein execution of the instructions by a processing device causes the processing device to:
train an ensemble of machine learning models based on training data that includes at least supplier data and project data, the ensemble of machine learning models having a tiered hierarchical configuration; and
execute the trained ensemble of machine learning models to automatically or semi-automatically generate data for pre-bid intelligent reports, proposals or bid documents.

17. The medium of claim 16, wherein the trained ensemble of machine learning models includes a first tier formed by at least two different machine learning models and a second tier formed by at least one other machine learning model that is different than the at least two machine learning models in the first tier.

18. The medium of claim 17, wherein the at least two machine learning models of the first tier include a random forest model and an extreme gradient boost model.

19. The medium of claim 17, wherein the at least one machine learning model of the second tier is a neural network model.

20. The medium of claim 17, wherein the at least one machine learning model in the second tier receives outputs from the at least two machine learning models in the first tier and generates a final output based on the outputs from the at least two machine learning models.
